(19) United States
(12) Patent Application Publication
(10) Pub. No.: US 2025/0196391 A1
(43) Pub. Date: Jun. 19, 2025

(54) Logging Machine

(71) Applicant: Lancaster Log Cabins, Gap, PA (US)

(72) Inventors: Lloyd Glick, Bird in hand, PA (US); Daniel Smucker, Gap, PA (US)

(73) Assignee: Lancaster Log Cabins, Gap, PA (US)

(21) Appl. No.: 18/542,067

(22) Filed: Dec. 15, 2023

(51) Int. Cl. B27B 31/00; B27B 31/06

(52) U.S. Cl. CPC B27B 31/006; B27B 31/06

(57) ABSTRACT

A logging machine including a conveyor assembly having a control box. The logging machine further having an initial conveyor assembly. The logging machine further having a secondary conveyor assembly. The logging machine further having an initial conveyor carving assembly. The logging machine further having a secondary conveyor carving assembly. The logging machine having a pair of end cabinets positioned on opposing sides of the secondary conveyor carving assembly.

### FIELD OF THE INVENTION

The present invention relates to a logging machine and, more particularly, to a logging machine for performing precision modifications to a log.

### BACKGROUND

In general, cutting lumber has been around for generations. However, the time and effort to manually maneuver the log into a machine and precisely cut the proper measurements is both a hinderance of time and effort. Consequently, for precise cuts, human error can cause mistakes which can be costly to fix when a precise measurement is needed. It is desirable to design a machine which prevents costly mistakes and performs precision cuts to the lumber. Therefore, there is a need for a logging machine.

As the foregoing illustrates, the invention provides the logging machine for performing precision cuts, incisions and carve outs of the lumber.

### SUMMARY

A logging machine including a conveyor assembly having a control box. The logging machine further having an initial conveyor assembly coupled to the conveyor assembly. The logging machine further having a secondary conveyor assembly adjacent the initial conveyor assembly. The logging machine further having an initial conveyor carving assembly coupled to the secondary conveyor assembly. The logging machine having a secondary conveyor carving assembly coupled to the initial conveyor carving assembly. The logging machine having a pair of end cabinets positioned on opposing sides of the secondary conveyor carving assembly, a material extended into a first end cabinet and then into a second end cabinet.

### BRIEF DESCRIPTION OF DRAWINGS

In the following, the present invention is described in more detail with references to the drawings in which:

FIG. 1 illustrates a perspective view of a logging machine according to the invention;

FIG. 2 illustrates a perspective view of a chop saw table assembly for a logging machine according to the invention;

FIG. 3 illustrates a top perspective view of FIG. 2;

FIG. 4 illustrates a front perspective view of FIG. 3;

FIG. 5 illustrates a top, front, left perspective view of the control box of FIG. 4;

FIG. 6 illustrates a perspective view of the chop saw table assembly coupled to the tabletop assembly;

FIG. 7 illustrates a perspective view of the tabletop assembly of FIG. 6;

FIG. 8 illustrates a top perspective view of FIG. 7;

FIG. 9 illustrates a front perspective view of FIG. 8;

FIG. 10 illustrates an enlarged view of FIG. 9;

FIG. 11 illustrates a top view of a material guide assembly;

FIG. 12 illustrates a bottom, rear, right side view of FIG. 11;

FIG. 13 illustrates a right side view of FIG. 12;

FIG. 14 illustrates another right side view of FIG. 13;

FIG. 15 illustrates a perspective view of a drill unit assembly;

FIG. 16 illustrates an enlarged view of FIG. 15;

FIG. 17 illustrates a cross sectional view of the drill unit assembly;

FIG. 18 illustrates another cross sectional view of FIG. 17;

FIG. 19 illustrates a top, rear, left view of FIG. 18;

FIG. 20 illustrates a top, front, right view of FIG. 19;

FIG. 21 illustrates a cross sectional view of FIG. 20;

FIG. 22 illustrates a perspective view of a carving assembly;

FIG. 23 illustrates an enlarged view of FIG. 22;

FIG. 24 illustrates a left side view of an initial conveyor carving assembly;

FIG. 25 illustrates a left side view of a second conveyor carving assembly;

FIG. 26 illustrates another left side view of the second conveyor carving assembly of FIG. 25;

FIG. 27 illustrates another left side view of the second conveyor carving assembly of FIG. 26;

FIG. 28 illustrates an exploded view of a crane assembly;

FIG. 29 illustrates a front, top, left side view of an end treatment cabinet assembly;

FIG. 30 illustrates a front, top, left side view of an inner portion of the end treatment cabinet assembly of FIG. 29;

FIG. 31 illustrates an enlarged view of FIG. 30;

FIG. 32 illustrates a rear, top, right side view of an inner portion of the end treatment cabinet assembly;

FIG. 33 illustrates a rear view of FIG. 32;

FIG. 34 illustrates a front view of the inner portion of the end treatment cabinet assembly of FIG. 33;

FIG. 35 illustrates another front view of the end treatment cabinet assembly of FIG. 34;

FIG. 36 illustrates a front, bottom right side perspective view;

FIG. 37 illustrates a front, bottom right side perspective view of FIG. 36;

FIG. 38 illustrates a front, bottom right side perspective view of FIG. 37;

FIG. 39 illustrates a front, bottom right side perspective view FIG. 38; and

FIG. 40 a illustrates a left side view of a belt assembly.

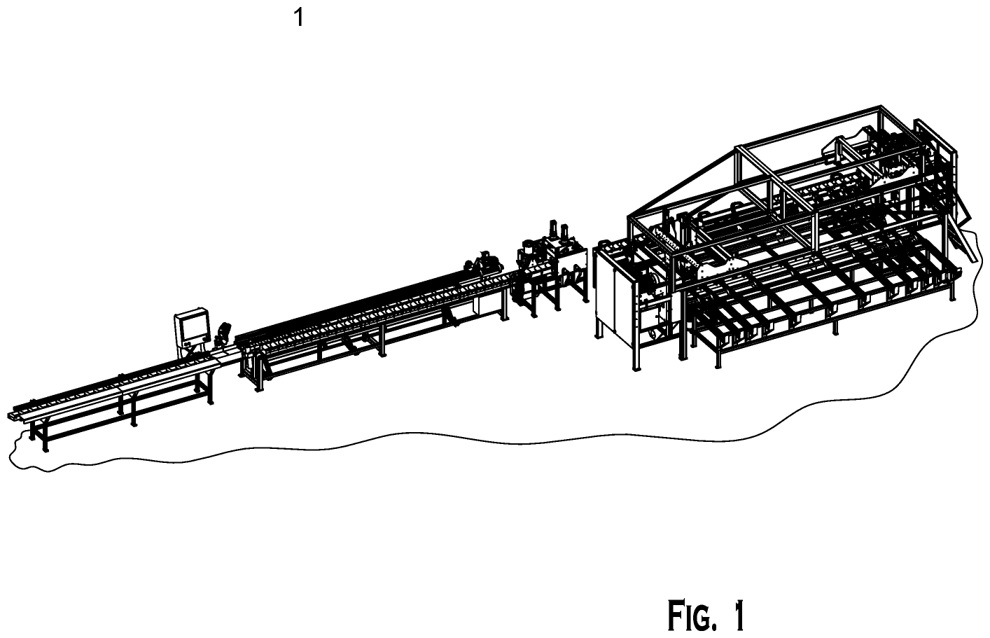

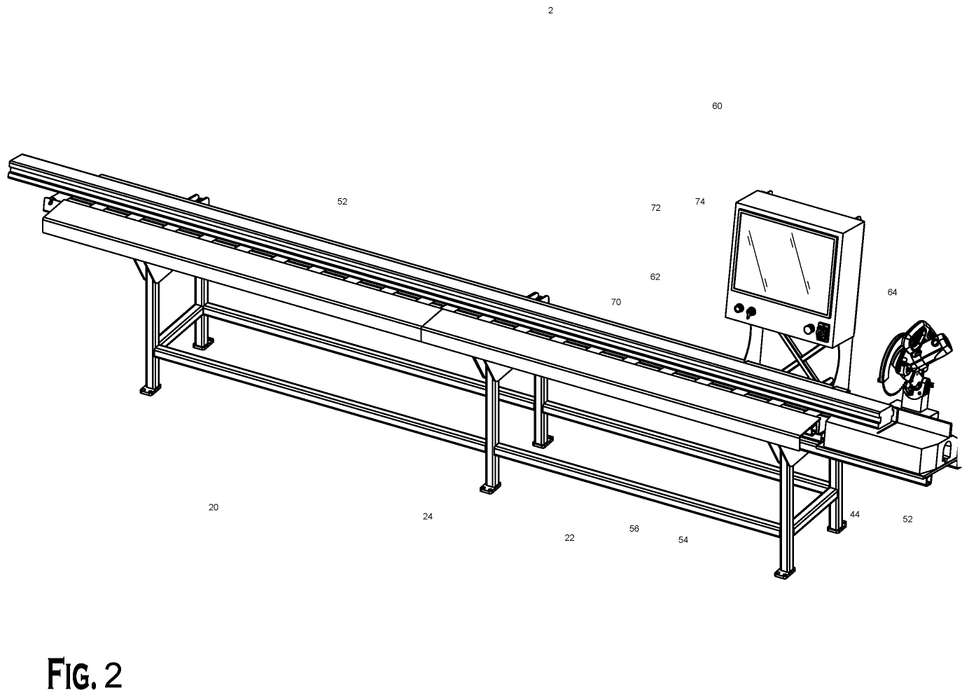

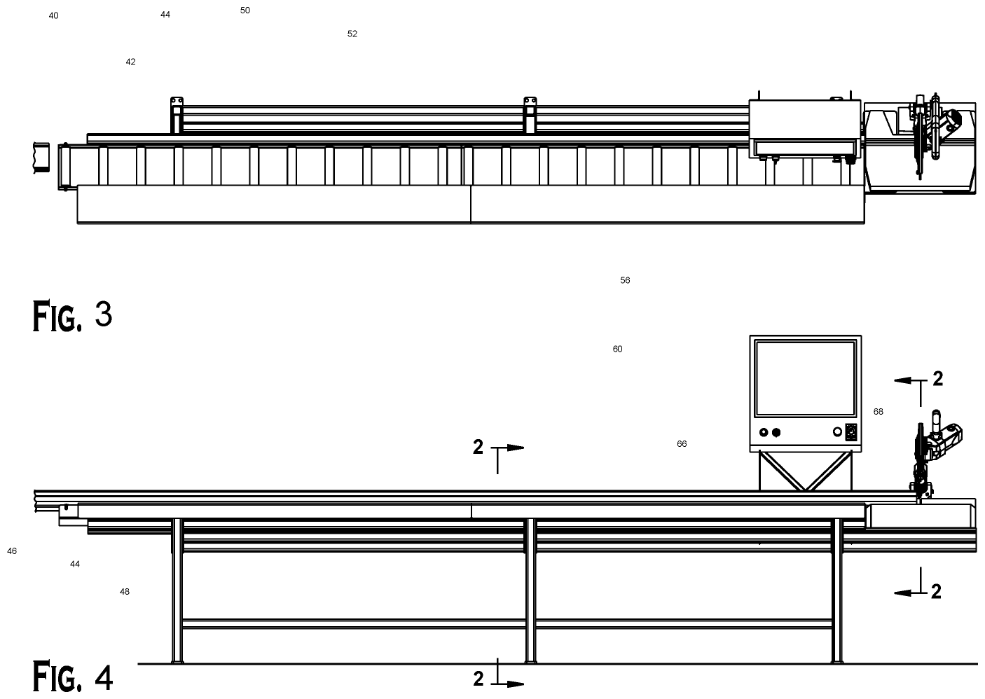

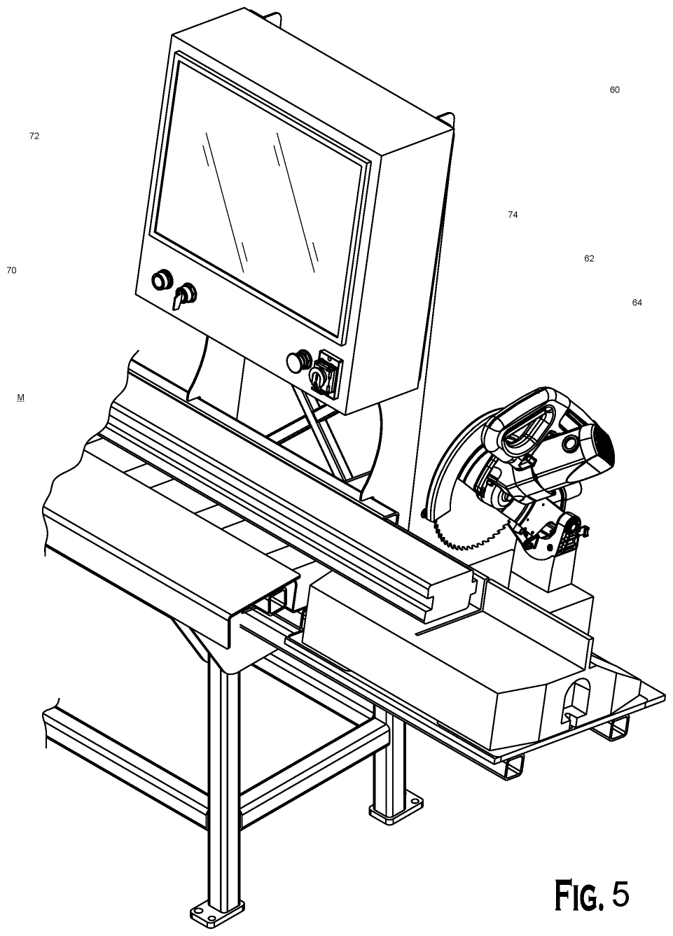

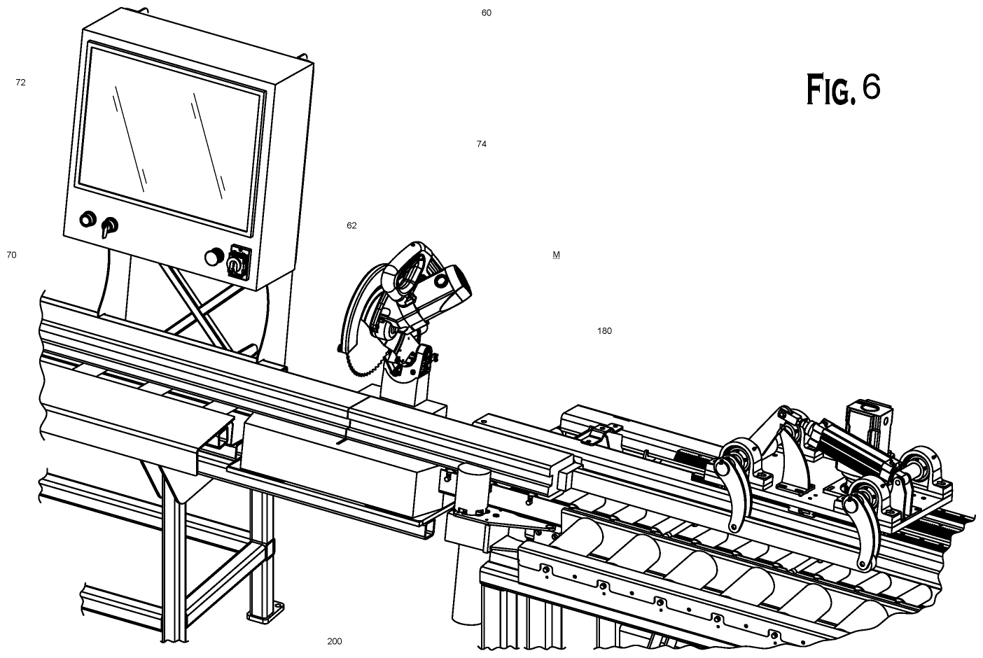

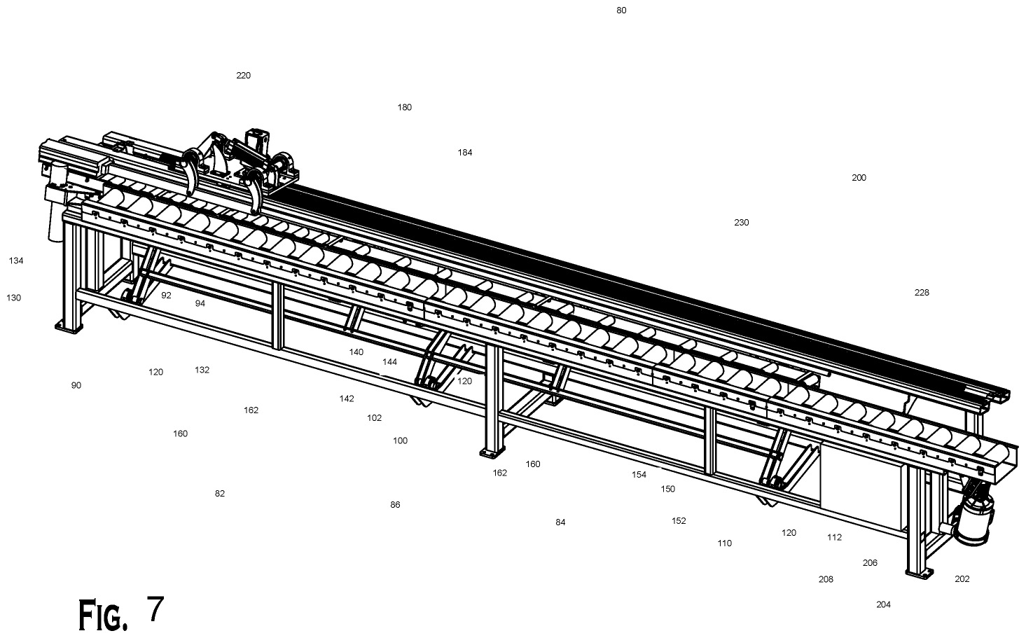

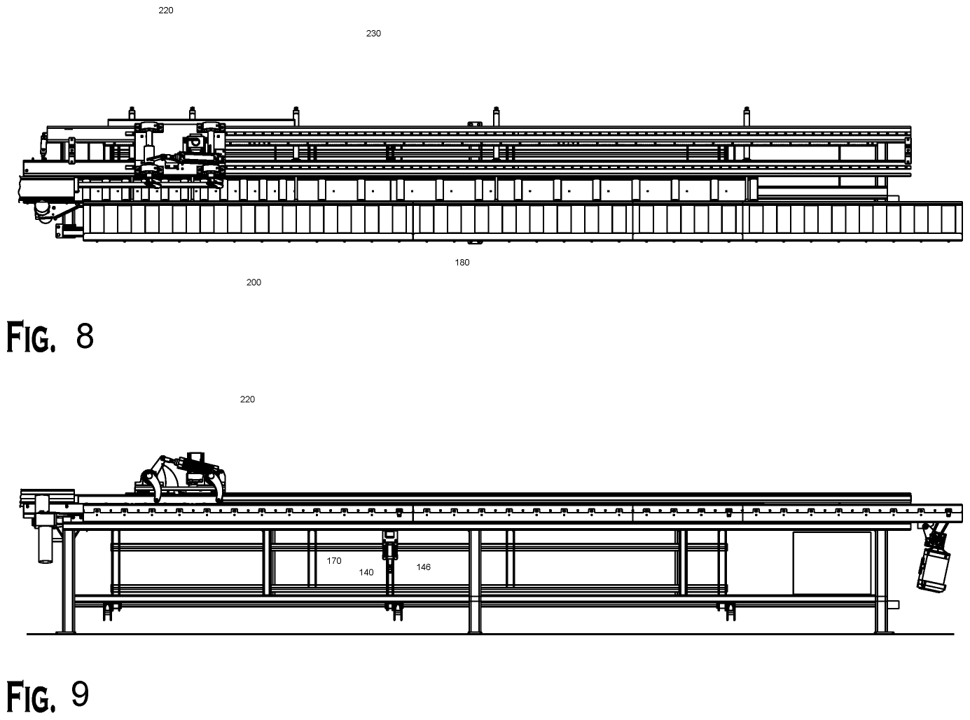

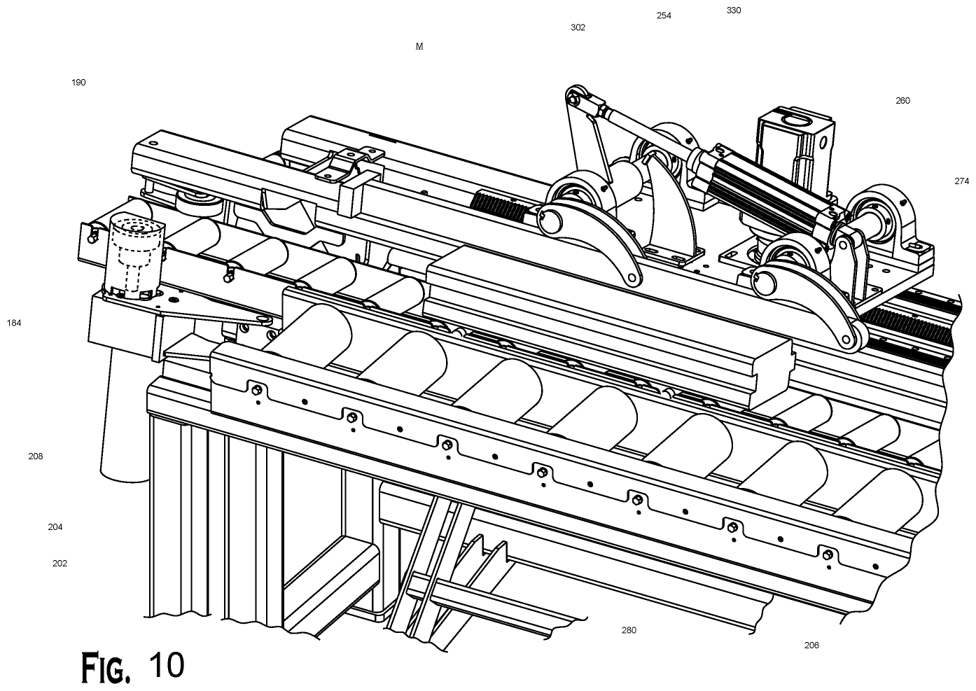

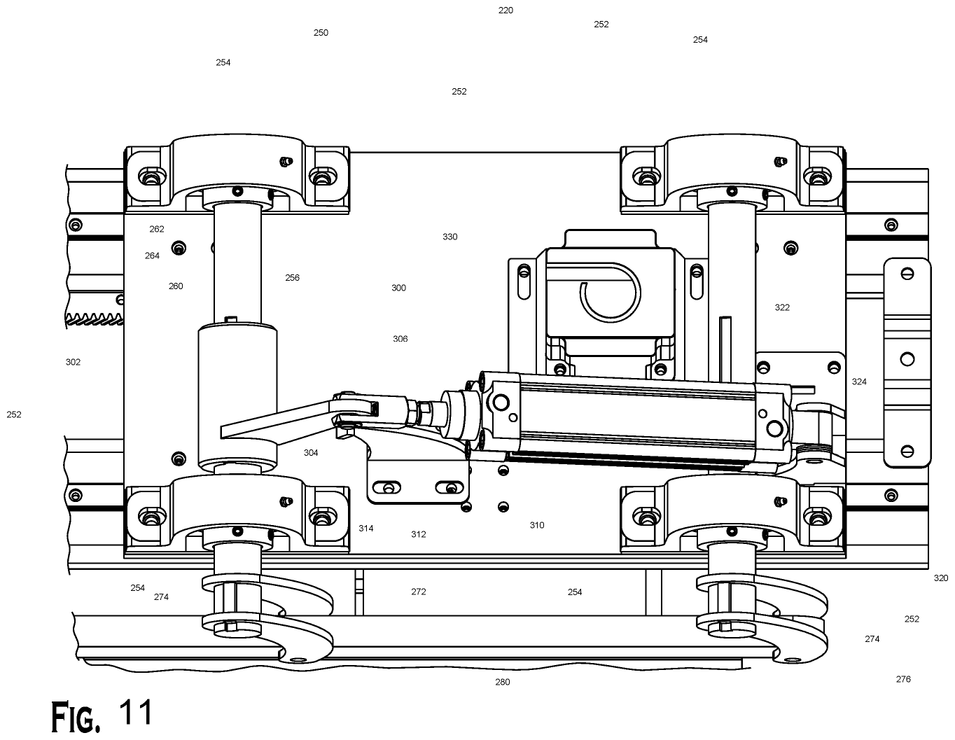

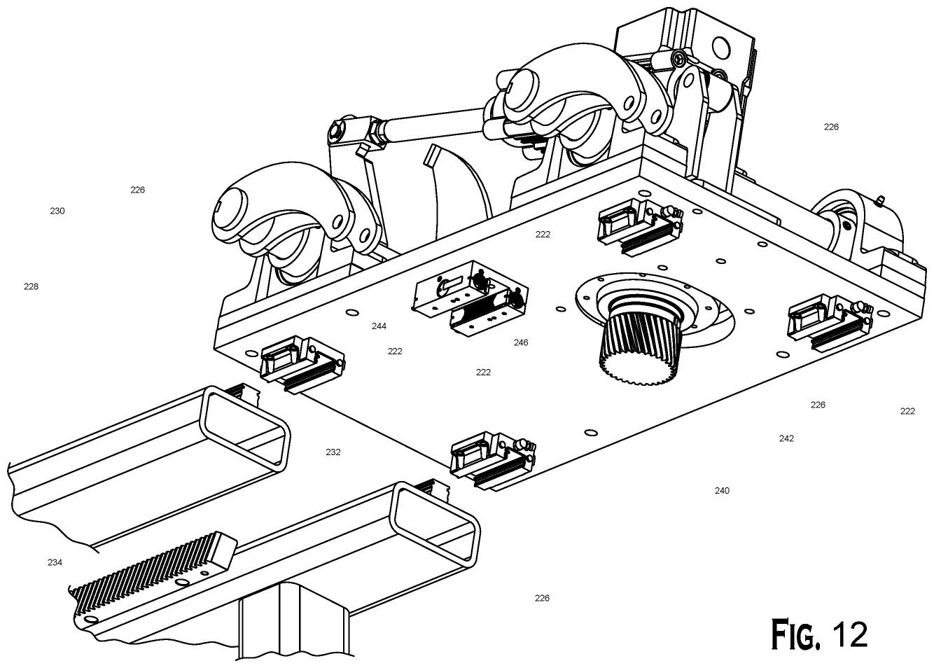

### DETAILED DESCRIPTION OF THE EMBODIMENTS

The present disclosure includes a logging machine according to the invention.

In the exemplary embodiment, the logging machine 1 includes a chop saw table assembly 2, a tabletop assembly 4, a drill unit assembly 6 (in alternate embodiment) and a carving assembly 8.

The chop saw table assembly 2 generally includes a plurality of support beams 20. The plurality of support beams 20 includes a plurality of horizontal beams 22 and a plurality of vertical beams 24. Each horizontal beam 22 of the plurality of horizontal beams 22 are elongated members. Each vertical beam 24 of the plurality of vertical beams 24 are elongated members. Each vertical beam 24 is positioned between at least two horizontal beams 22 of the plurality of horizontal beams 22.

The chop saw table assembly 2 further includes a plurality of belt supports 30. The plurality of belt supports 30 include a front belt support, a middle belt support and an end belt support allowing for the positioning of the conveyor assembly 40.

In the exemplary embodiment, the conveyor assembly 40 includes a base plate 42, a pair of side plates 44, a pair of support beams 48, a plurality of rollers 50, a guide rail 52, a cover rail 54 and a cover plate 56.

As shown, the base plate 42 is an elongated member extending the length of the conveyor assembly 40.

As shown, the pair of side plates 44 are positioned at opposite edges of the base plate 42. Each side plate 44 is an elongated member. Each side plate 44 further includes a plurality of roller receivers 46. Each roller receiver 46 is a passageway way extending through each of the side plates 44.

As shown, the pair of support beams 48 are positioned under the base plate 42. Each support beam 48 is an elongated member extending the length of the base plate 42.

In the exemplary embodiment, the plurality of rollers 50 extend along the base plate 42 and are inserted within each of the roller receivers 46. Each roller 50 is a cylindrically formed member.

As shown, the guide rail 52 is an elongated member positioned adjacent and above one side plate 44 of the pair of side plates 44. The guide rail 52 extends the length of the base plate 42.

In the exemplary embodiment, the cover rail 54 is an elongated member on an opposing side from the guide rail 52. The cover rail 54 extends the length of the base plate 42.

In the exemplary embodiment, the cover plate 56 is an L-shaped plate member extending the length of the base plate 42. The cover plate 56 is positioned on top of the cover rail 54 and the plurality of belt supports 30. Additionally, the cover plate 56 is positioned above the pair of side plates 44.

In the exemplary embodiment, the command assembly 60 includes a pair of command support sheets 62, a pair of cross beams 70 and a control box 72.

The pair of command support sheets 62 are perpendicular to the conveyor assembly 40. Each command support sheet 62 includes a guide rail receiver 64. The guide rail receiver 64 is a cutout extending through each of the command support sheets 62. Each command support sheet 62 further includes a command box receiver 66. The command box receiver 66 is a ledge. Each command support sheet 62 further includes a support beam receiver 68. The support beam receiver 68 is a cutout extending through each of the command support sheets 62.

The pair of cross beams 70 are positioned between the pair of command support sheets 62 and form an X-shape. Each cross beam 70 is an elongated structure.

The control box 72 is positioned on the command box receiver 66. The control box 72 is a rectangular structure with a plurality of controls for inputting dimensions of log cuts. The control box 72 further includes a control media screen 74.

The material glider assembly 80 generally includes a plurality of support beams 82. The plurality of support beams 82 include a plurality of horizontal beams 84 and a plurality of vertical beams 86. Each horizontal beam 84 of the plurality of horizontal beams 84 are elongated members. Each vertical beam 86 of the plurality of vertical beams 86 are elongated members. Each vertical beam 86 is positioned between at least two horizontal beams 84 of the plurality of horizontal beams 84.

The material glider assembly 80 further includes a lower frame 90. The lower frame 90 includes a pair of front lower frame supporters 92, a pair of central lower frame supporters 100 and a pair of rear lower frame supporters 110.

As shown, the pair of front lower frame supporters 92 are sheet like members. Each front lower frame supporter 92 includes a pair of beam receivers 94. Each beam receiver 94 is a cutout positioned at each end of the front lower frame supporter 92.

In the exemplary embodiment, the material glider assembly 80 further includes a pair of central lower frame supporters 100. Each central lower frame supporter 100 is a sheet like member. Each central lower frame supporter 100 includes a pair of beam receivers 102. Each beam receiver 102 is a cutout positioned at each end of the central lower frame supporter 100.

In the exemplary embodiment, the material glider assembly 80 further includes a pair of rear lower frame supporters 110. The rear lower frame supporters 110 are sheet like members. Each rear lower frame supporter 110 includes a pair of beam receivers 112. Each beam receiver 112 is a cutout positioned at each end of the rear lower frame supporter 110.

In the exemplary embodiment, the lower frame 90 further includes a rotational socket 120. The rotational socket 120 is positioned between each pair of front lower frame supporters 92, central lower frame supporters 100 and rear lower frame supporters 110. The rotational socket 120 is a circular member.

The lower frame 90 further includes a pair of front middle frame supporters 130, a pair of central middle frame supporters 140 and a pair of rear middle frame supporters 150. Each front middle frame supporter 130 is a sheet like member.

Each front middle frame supporter 130 includes a socket connector 132. The socket connector 132 is a passageway extending through each of the front middle frame supporters 130 permitting the socket of the rotational socket 120 to be attached. Each front middle frame supporter 130 further includes a pair of beam slots 134 extending through each of the front middle frame supporters 130. The beam slot 134 is a passageway positioned at a middle and an upper portion of each of the front middle frame supporters 130.

In the exemplary embodiment, each central middle frame supporters 140 is a sheet like member. Each central middle frame supporter 140 includes a socket connector 142. The socket connector 142 is a passageway extending through each of the central middle frame supporters 140 permitting the rotational socket 120 to be attached. Each central middle frame supporter 140 further includes a pair of beam slots 144 extending through each of the central middle frame supporters 140. The beam slot 144 is a passageway positioned at a middle and an upper portion of each of the central middle frame supporters 140. Each central middle frame supporter 140 further includes a piston connector 146. The piston connector 146 is a passageway extending through each central middle frame supporter 140.

In the exemplary embodiment, each rear middle frame supporter 150 is a sheet like member. Each rear middle frame supporter 150 includes a socket connector 152. The socket connector 152 is a passageway extending through each of the rear middle frame supporters 150 permitting the rotational socket 120 to be attached. Each rear middle frame supporter 150 further includes a pair of beam slots 154 extending through each of the rear middle frame supporters 150. Each beam slot 154 is a passageway positioned at a middle and an upper portion of each of the rear middle frame supporter 150.

The lower frame 90 further includes a pair of upper frame supporters 160 positioned between the pair of front middle frame supporters 130, the pair of central middle frame supporters 140 and the pair of rear middle frame supporters 150.

In the exemplary embodiment, each individual upper frame supporter 160 is a sheet member. Each upper frame supporter 160 includes a beam receiver 162. Each upper frame supporter 160 further includes an upper frame coupler 164.

In the exemplary embodiment, the lower frame 90 further includes a main hydraulic piston 170. The main hydraulic piston 170 comprises the basic parts of a hydraulic piston, one skilled in the art would understand the workings. The main hydraulic piston 170 is coupled to the piston connector 146.

In the exemplary embodiment, the material glider assembly 80 further includes an initial conveyor assembly 180.

The initial conveyor assembly 180 includes a base plate 182, a pair of side plates 184, a pair of support beams 188 and a plurality of rollers 190.

The base plate 182 is an elongated member extending the length of the initial conveyor assembly 180.

The pair of side plates 184 are positioned at opposite edges of the base plate 182. Each side plate 184 is an elongated member. Each side plate 184 further includes a plurality of roller receivers 186. Each roller receiver 186 is a passageway way extending through the side plate 184.

The pair of support beams 188 are positioned under the base plate 182. Each support beam 188 is an elongated member extending the length of the base plate 182.

The plurality of rollers 190 extend along the base plate 182 and are inserted within each of the roller receivers 186. Each roller 190 is a cylindrically formed member.

In the exemplary embodiment, the material glider assembly 80 further includes a secondary conveyor assembly 200. The secondary conveyor assembly 200 is positioned adjacent and abutting the initial conveyor assembly 180. The initial conveyor assembly 180 is coupled to the conveyor assembly 40 of the chop saw table assembly 2.

The secondary conveyor assembly 200 of the tabletop assembly 4 includes a base plate 202, a pair of side plates 204 and a plurality of rollers 208.

The base plate 202 is an elongated member extending the length of the secondary conveyor assembly 200.

The pair of side plates 204 are positioned at opposite edges of the base plate 202. Each side plate 204 is an elongated member. Each side plate 204 further includes a plurality of roller receivers 206. Each roller receiver 206 is a passageway way extending through each of the side plates 204.

The plurality of rollers 208 extend along the base plate 202 and are inserted within each of the roller receivers 206. Each roller 208 is a cylindrically formed member.

The material glider assembly 80 further includes a material guide assembly 220.

The material guide assembly 220 includes a plurality of guiding beam mounts 222. Each guiding beam mount 222 is a plate like structure with a cutout. Each guiding beam mount 222 includes a pair of guiding beam cutouts 226 extending through each guiding beam mount 222.

The material guide assembly 220 further includes a pair of guiding beams 228. Each guiding beam 228 is an elongated member. Each guiding beam 228 further includes a track 230 positioned on top and extending a length of each of the guiding beams 228. On an inner side of the one guiding beam 228 of the pair of guiding beams includes an inner track 232. The inner track 232 extends a length of the guiding beam 228 and includes a plurality of teeth 234.

The material guide assembly 220 further include a rotatory device 240. The rotatory device 240 is circular and positioned between the guiding beams 228. The rotatory device 240 includes a plurality of teeth 242 that couple to the inner track 232.

The material guide assembly 220 further includes a securing mount 244. The securing mount 244 is a u-shaped structure positioned behind one of the guiding beam mounts 222. The securing mount 244 further includes a securing passageway 246. The securing passageway 246 is extends through the securing mount 244.

In the exemplary embodiment, the material guide assembly 220 further includes a plurality of rotation mounts 250. Each rotation mount 250 includes a base member 252. The base member 252 is an elongated rectangle. Each rotation mount 250 further includes an arched member 254 positioned on top of the base member 252. The arched member 254 further includes a rotation beam receiver 256. The rotation beam receiver 256 is a passageway.

The material guide assembly 220 further includes a pair of rotation beams 260 extending across the base member 252.

The material guide assembly 220 further includes a plurality of rotational beam connectors 262. Each rotational beam connector 262 is circular. Each rotational beam connector 262 further includes a passageway 264.

The material guide assembly 220 further includes a pair movers 270. Each mover 270 generally includes a pair of elongated arches 272. One skilled in the art would understand the applicant's design is not the exclusive embodiment. Each elongated arch 272 further includes a beam receiving passageway 274. Each elongated arch 272 further includes a fastener receiving passageway 276.

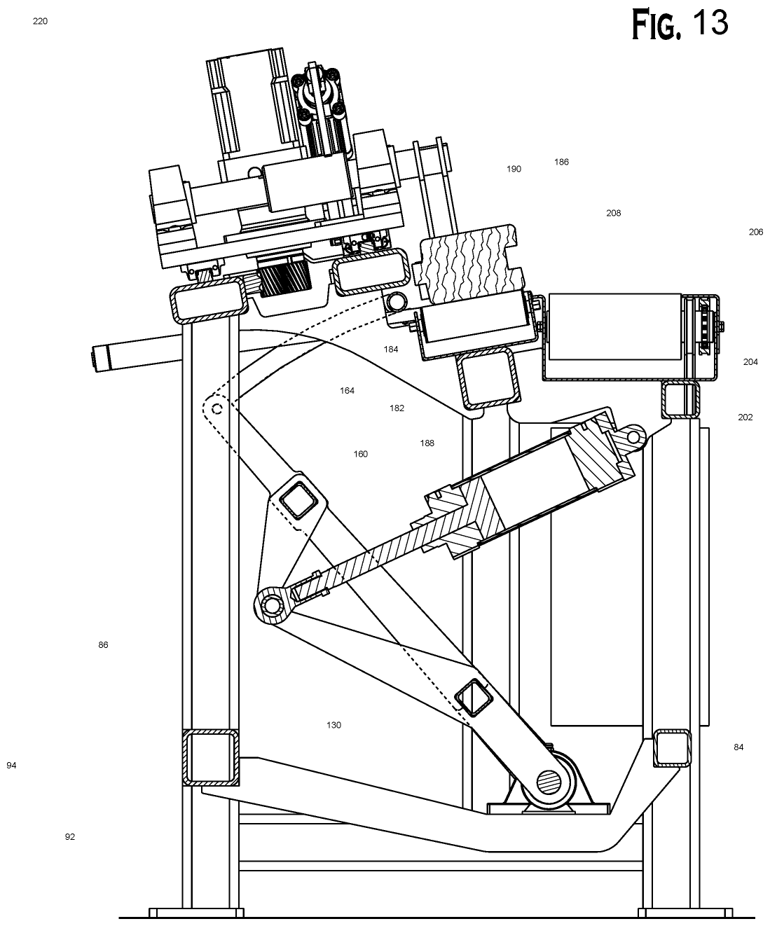

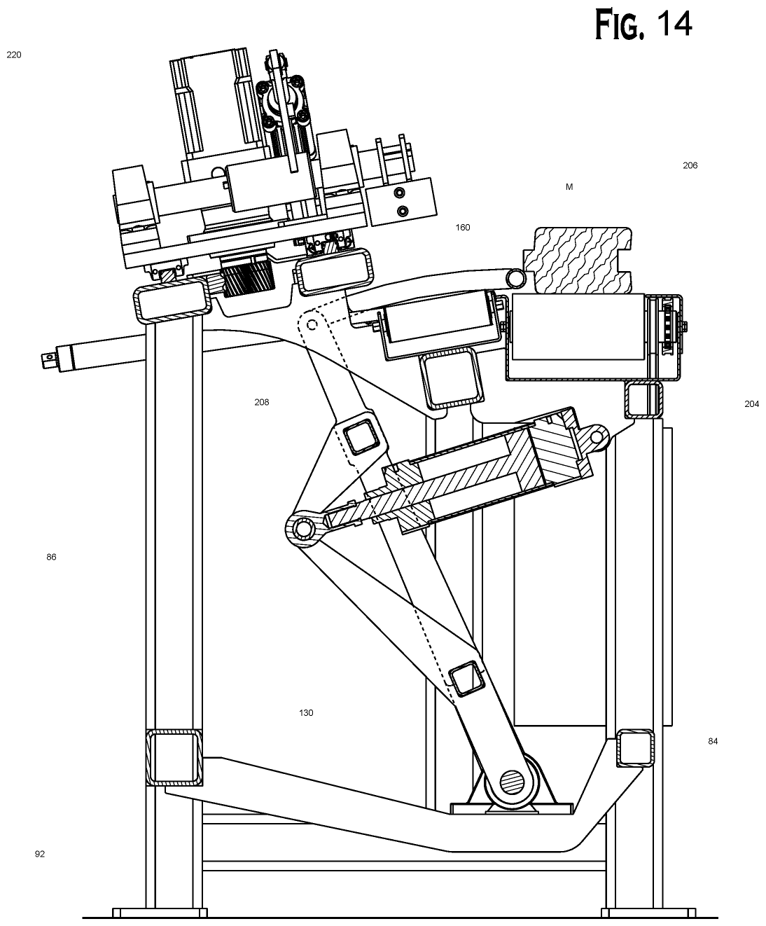

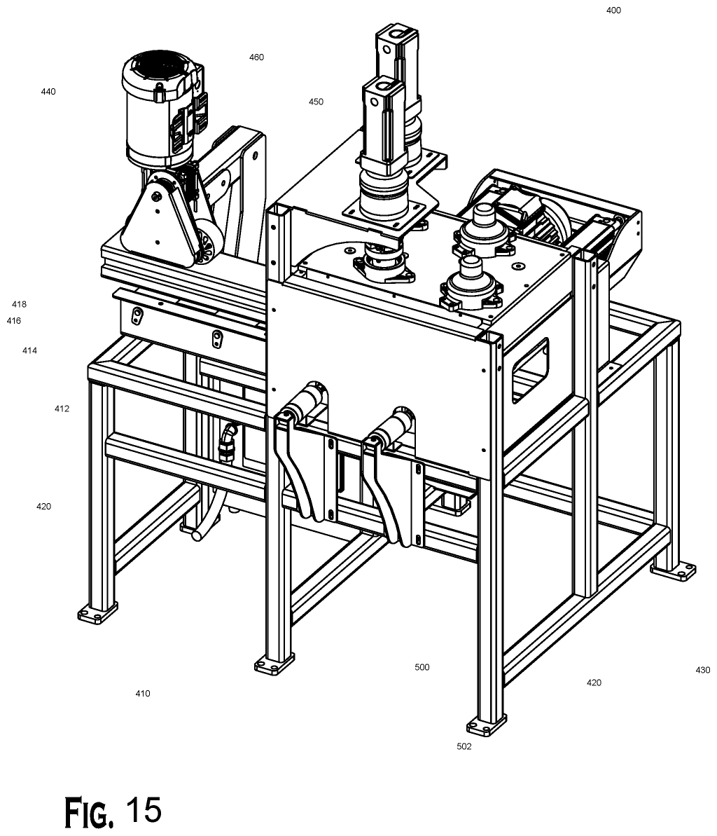

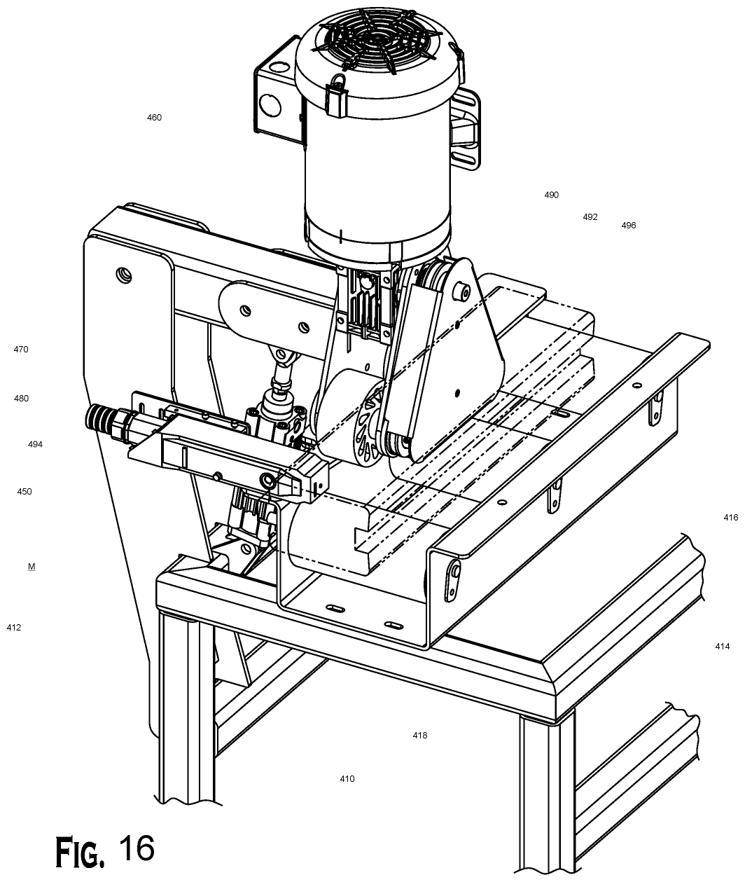

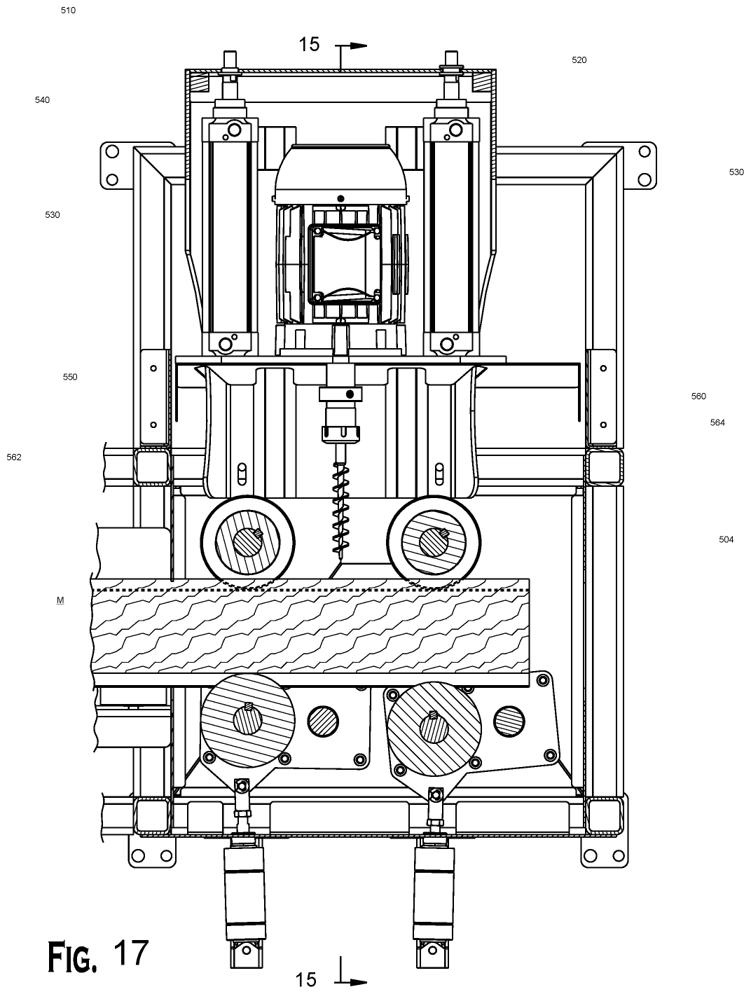

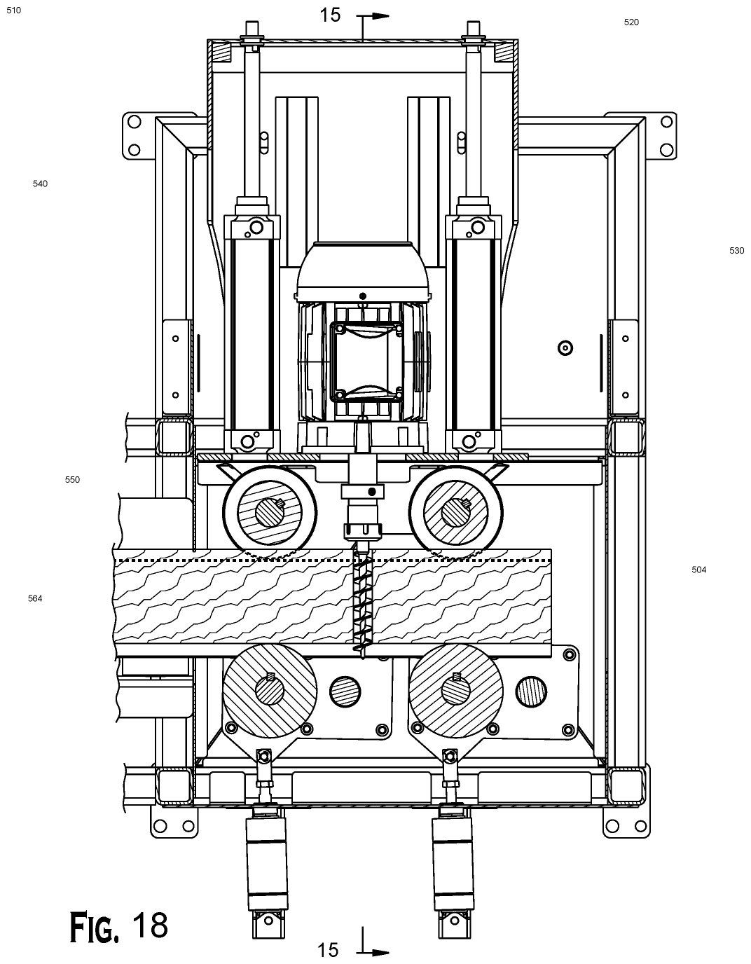

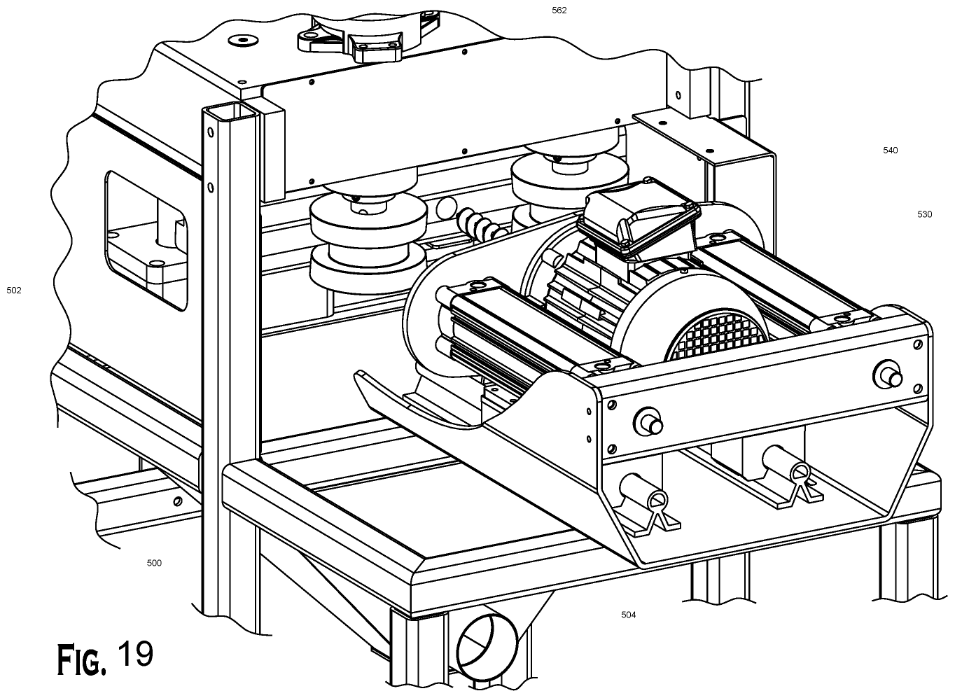

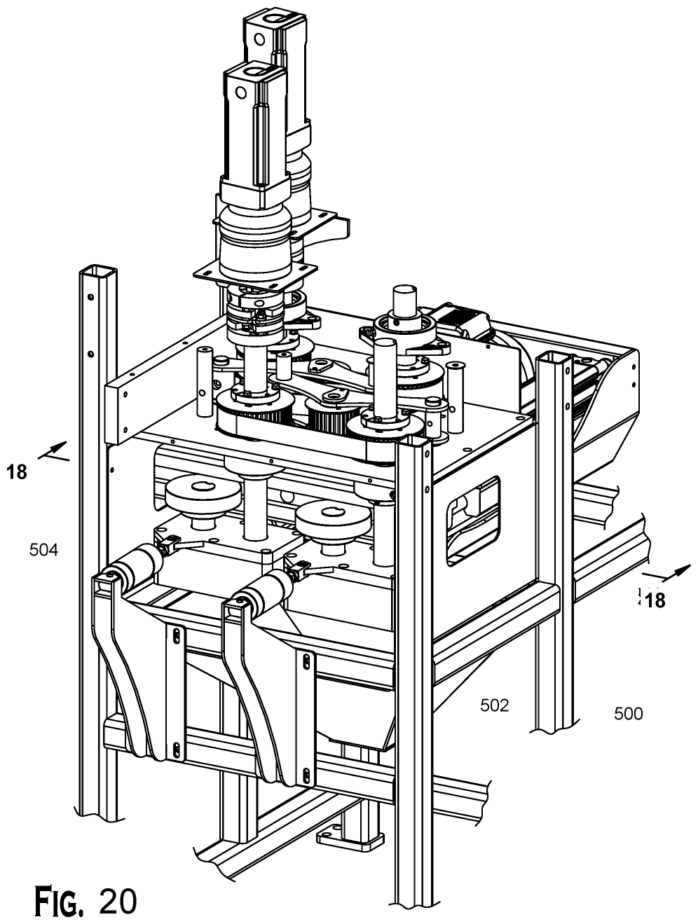

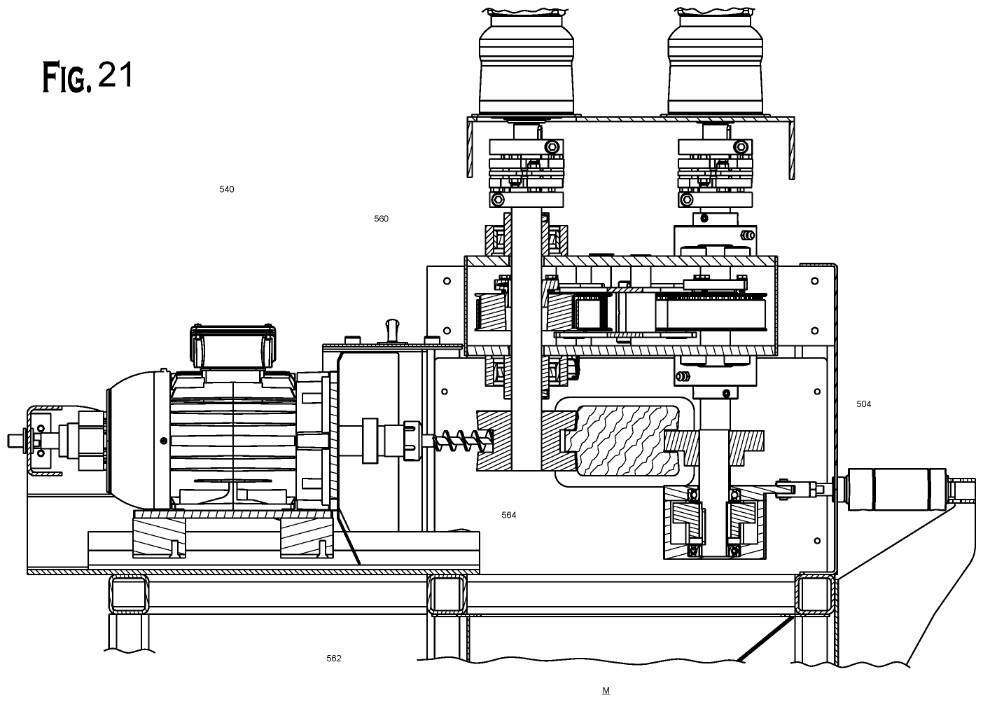

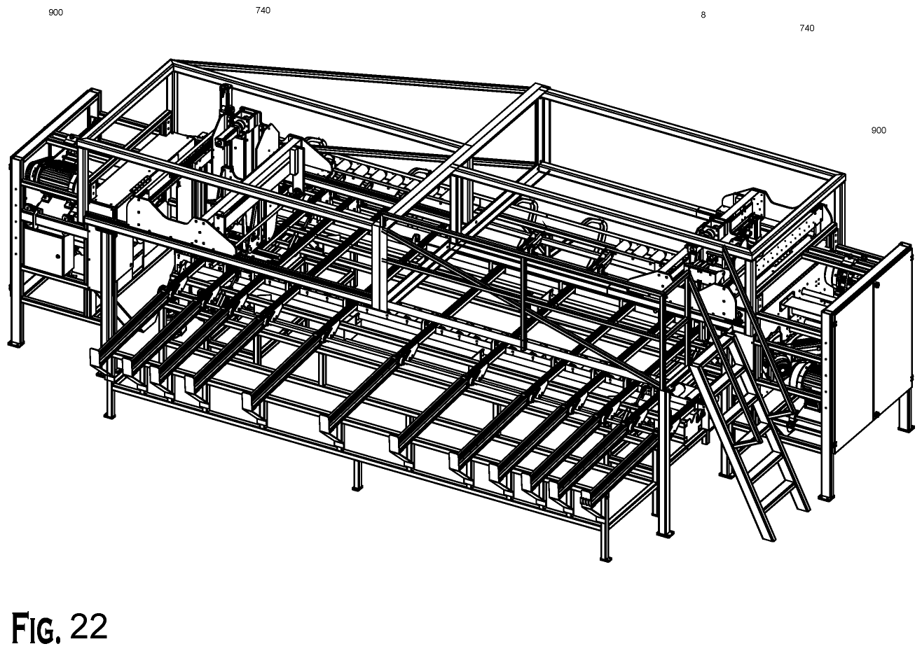

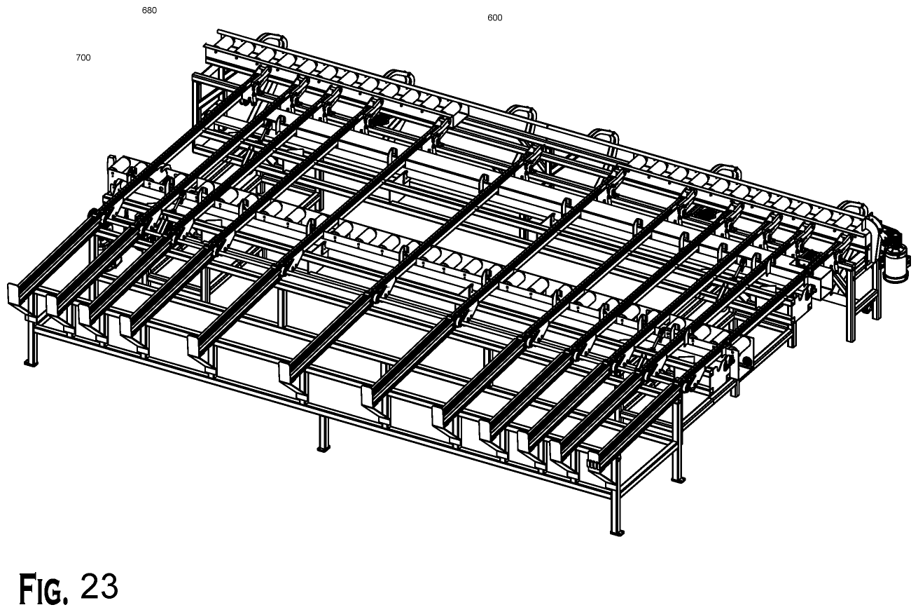

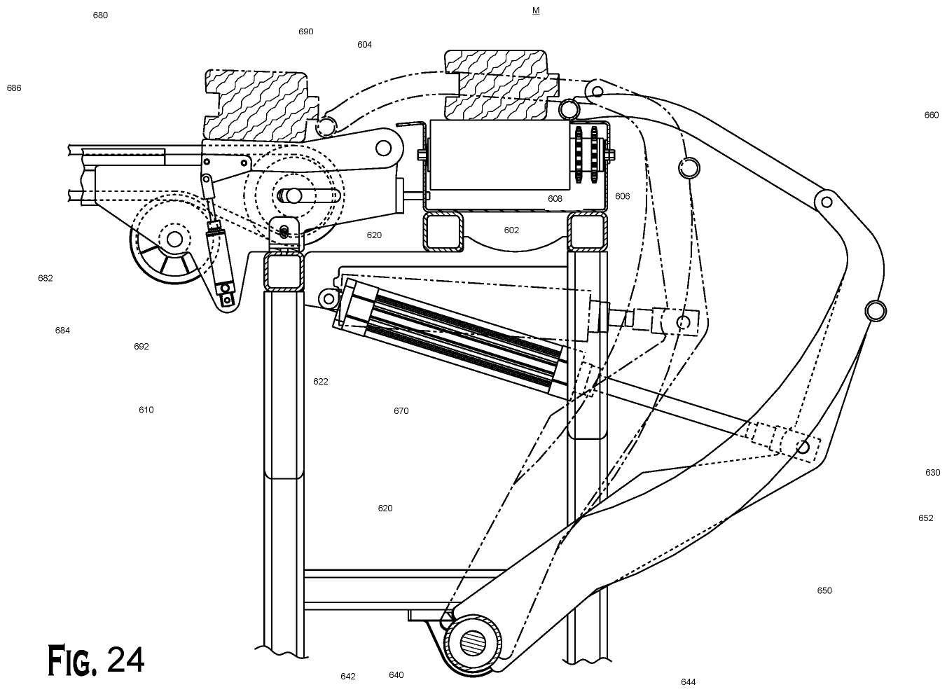

In the exemplary embodiment and as illustrated in FIG. 11, the material guide assembly 220 further includes a guiding fence 280. The guiding fence 280 is an elongated T-shaped member positioned between each of the elongated arches 272 of the pair of movers 270.

The material guide assembly 220 further includes a hydraulic piston support assembly 290. The hydraulic piston support assembly 290 generally includes an upper piston support 300, a central piston support 310 and a lower piston support 320.

The upper piston support 300 generally includes a cylindrical member 302 positioned around one of the rotation beams 260. The upper piston support 300 further includes an elongated sheet 304 protruding from the cylindrical member 302. The upper piston support 300 further includes a connector 306 coupled to the elongated sheet 304.

The central piston support 310 includes a base 312. The base 312 is a rectangular member. The central piston support 310 further includes an elongated sheet 314 protruding from the base 312. The elongated sheet 314 is coupled to the connector 306.

The lower piston support 320 includes a base 322. The base 322 is a rectangular member. The lower piston support 320 further includes a pair of elongated sheet members 324 protruding from the base 322.

The material guide assembly 220 further includes a hydraulic piston 330. The hydraulic piston 330 is a standard hydraulic piston. One skilled in the art would understand the inner working the hydraulic piston.

In an alternate exemplary embodiment, a drill unit assembly 400 is coupled to the secondary conveyor assembly 200. The drill unit assembly 400 generally includes a frame assembly 410.

The frame assembly 410 includes a base plate 412. The frame assembly 410 further includes a pair of side plates 414 positioned on each side of the base plate 412. The frame assembly 410 further includes a plurality of receivers 416 extending through each side plate 414. The frame assembly 410 further includes a plurality of rollers 418 positioned through the plurality of receivers 416 to move the material into the drill unit assembly 400.

The frame assembly 410 further includes a plurality of horizontal beams 420. Each of the horizontal beams 420 is elongated. A portion of the horizontal beams 420 are positioned under the base plate 412.

The frame assembly 410 further includes a plurality of vertical beams 430. Each of the vertical beams 430 is elongated. The plurality of horizontal beams 420 and the plurality of vertical beams 430 form the frame assembly 410.

In the exemplary embodiment, the drill unit assembly 400 further includes an arm assembly 440.

The arm assembly 440 generally includes a pair of support plates 450. Each support plate 450 is elongated and coupled to the frame assembly 410.

The arm assembly 440 further includes an arm member 460. The arm member 460 is an elongated beam extending horizontally from the pair of support plates 450.

The movement assembly 440 further includes a hydraulic piston support 470. The hydraulic piston support 470 is a pair of plate members positioned on each side of the arm member 460.

The movement assembly 440 further includes a hydraulic piston 480. One skilled in the art would understand the inner workings of the hydraulic piston.

The movement assembly 440 further includes a material driver 490. The material driver 490 generally includes a pair of support plates 492. Each support plate 492 is triangularly shaped.

The material driver 490 further includes a pair of wheels 494 positioned between the pair of support plates 492 to push material. The movement assembly 440 further includes a motor 496 coupled to the wheels 494. The motor 496 is positioned against one of the support plates 492.

The drill unit assembly 400 further includes a main frame 500.

The main frame 500 is a rectangular like structure positioned on the frame assembly 410. The main frame 500 further includes a material receiver 502. The material receiver 502 is a passageway extending through the main frame 500 of the drill unit assembly 400.

The main frame 500 further includes a plurality of movers 504. The plurality of movers 504 are circular members positioned along the material receiver 502 to transport the material M through the material receiver 502 or to restrict movement of the material M within the material receiver 502. The plurality of movers 504 spin clockwise or counterclockwise depending on an operators need.

The drill unit assembly 400 further includes a drilling unit 510. The drilling unit 510 includes a housing 520. The housing 520 is a cradle like structure.

As illustrated in FIG. 17, the drilling unit 510 further includes a pair of hydraulic pistons 530 positioned within the housing 520. One skilled in the art would understand the inner workings of the hydraulic piston.

The drilling unit 510 further includes a drilling motor 540 positioned between the pair of hydraulic pistons 530.

The drilling unit 510 further includes a drilling shaft 550 coupled to the drilling motor 540. The drilling shaft 550 is a cylindrical member. The drilling shaft 550 extends and retracts.

The drilling unit 510 further includes a drilling head 560. The drilling head 560 is coupled to one end of the drilling shaft 550. The drilling head 560 further includes a spindle 562. The spindle 562 is a cylindrical member gradually tapering away from the drilling head 560. The spindle 562 further includes a thread 564 extending a length of the spindle 562.

In either of the exemplary embodiments, the secondary conveyor assembly 200 or the drill unit assembly 400 is coupled to an initial conveyor carving assembly 600.

The carving assembly 8 generally includes the initial conveyor carving assembly 600, the belt assembly 680, the second conveyor carving assembly 700, a pair of crane assemblies 740 and a pair of end cabinets 900.

The initial conveyor carving assembly 600 includes a base plate 602, a pair of side plates 604 and a plurality of rollers 608.

The base plate 602 is an elongated member extending the length of the initial conveyor carving assembly 600. The pair of side plates 604 are positioned at opposite edges of the base plate 602. Each side plate 604 is an elongated member extending the length of the base plate 602. Each side plate 604 further includes a plurality of roller receivers 606. Each roller receiver 606 is a passageway extending through the side plate 604. The initial conveyor carving assembly 600 further includes a plurality of rollers 608 positioned within the roller receivers 606.

The initial conveyor carving assembly 600 further includes a plurality of vertical beams 610. A portion of the vertical beams 610 extend from the base plate 602.

The initial conveyor carving assembly 600 further includes a plurality of horizontal beams 620. The plurality of horizontal beams 620 are coupled to the plurality of vertical beams 610 to maintain structural support. The plurality of horizontal beams 620 further include a connector 622 positioned adjacent the horizontal beam 620 and below the base plate 602.

The initial conveyor carving assembly 600 further includes a relocating assembly 630. The relocating assembly 630 includes a rotational socket 640. The rotational socket 640 includes a mount 642. The mount 642 is a triangular member coupled to the horizontal beam 620. The rotational socket 640 further includes a socket 644 positioned on the mount 642.

The relocating assembly 630 further includes a lower arm member 650. The lower arm member 650 couples to the socket 644 allowing for the lower arm member 650 to rotate as shown. The lower arm member 650 further includes a coupler 652 positioned in a central portion of the lower arm member 650.

The relocating assembly 630 further includes an upper arm 660 coupled to the lower arm member 650.

The relocating assembly 630 further includes a hydraulic piston 670. One skilled in the art would understand the components of the hydraulic piston. The hydraulic piston 670 is connected to the connector 622 and the coupler 652.

In the exemplary embodiment, the initial conveyor carving assembly 600 further includes a belt assembly 680 coupled to the side plate 604. The belt assembly 680 includes a main belt frame 682. The main belt frame 682 couples to the side plate 604.

The belt assembly 680 further includes a plurality of pulleys 684 positioned within the main belt frame 682. The belt assembly 680 further includes a belt 686 intertwined with the plurality of pulleys 684 allowing for material to be transported downwards along the belt assembly 680.

The belt assembly 680 further includes a flap 690 positioned above the main belt frame 682. The flap 690 is a pair of elongated members able to rotate in order for the material to slide onto the belt 686. The flap 690 further includes a hydraulic piston 692 coupled to the flap 690 and the main belt frame 682.

A second conveyor carving assembly 700 couples to the belt assembly 680. The second conveyor carving assembly 700 includes a base plate 702, a pair of side plates 704 and a plurality of rollers 708.

The base plate 702 is an elongated member extending the length of the second conveyor carving assembly 700. The pair of side plates 704 are positioned at opposite edges of the base plate 702. Each side plate 704 is an elongated member. Each side plate 704 further includes a plurality of roller receivers 706. Each roller receiver 706 is a passageway way extending through the side plate. The second conveyor carving assembly 700 further includes a plurality of rollers 708 positioned within the roller receivers 706.

The second conveyor carving assembly 700 further includes a plurality of vertical beams 710. Each of the vertical beams 710 extend from the base plate 702. The second conveyor carving assembly 700 further includes a plurality of horizontal beams 720. The plurality of horizontal beams 720 are coupled to the plurality of vertical beams 710.

The second conveyor carving assembly 700 further includes a blocker 722. The blocker 722 is a blunt member. The blocker 722 further includes a coupler 724. The coupler 724 connects to the belt assembly 680. The blocker 722 further includes a piston coupler 726 positioned above the coupler 724.

The second conveyor carving assembly 700 further includes a hydraulic piston 730. One skilled in the art would understand the inner working of the hydraulic piston 730. The hydraulic piston is coupled to the belt assembly 680. Additionally, the hydraulic piston 730 is connected to the piston coupler 726.

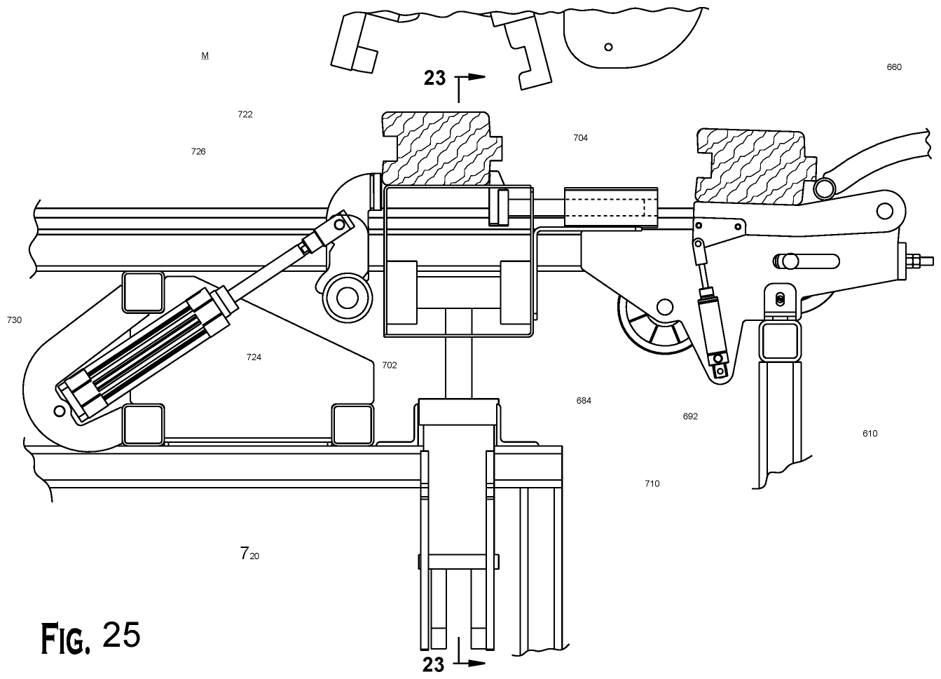

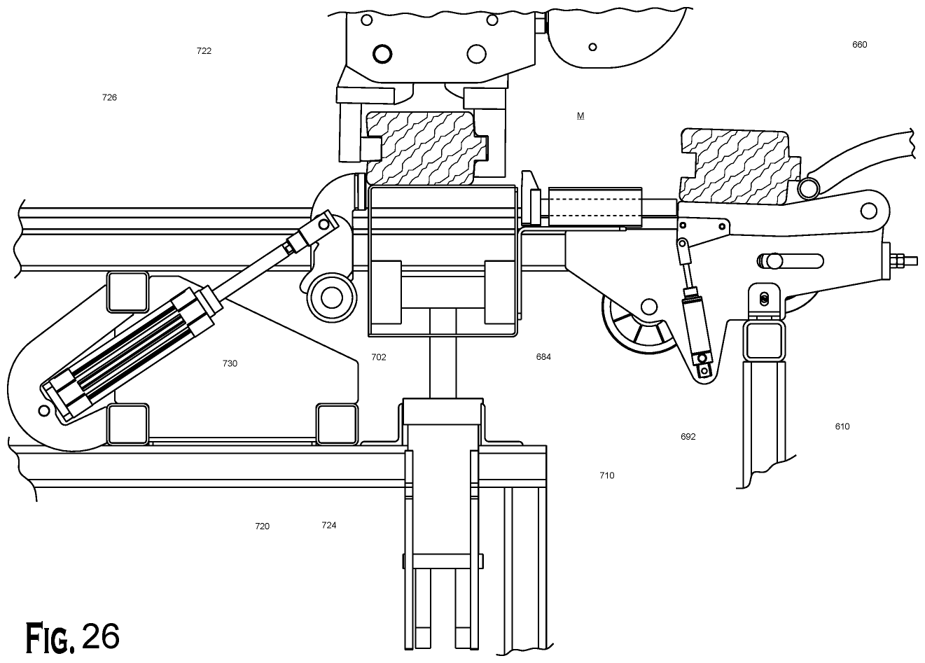

As illustrated in FIG. 25, the hydraulic piston 730 permits the blocker 722 to extend upwards to prevent matter from continuing to move on the belt assembly 680 for either of the crane assemblies 740.

The second conveyor carving assembly 700 further includes an arm 732 extending from the side plate 704.

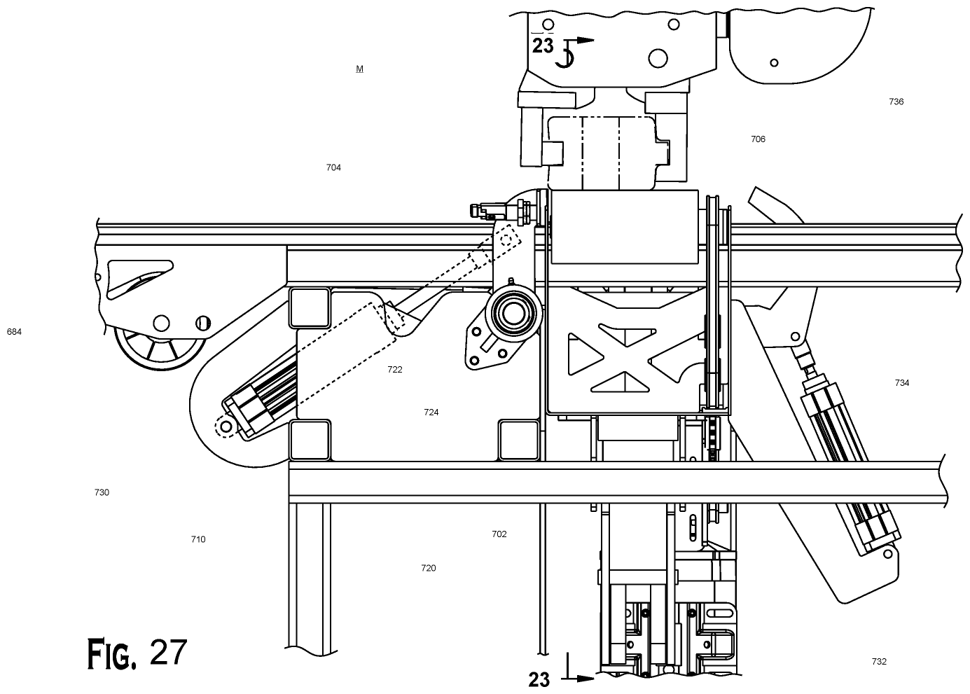

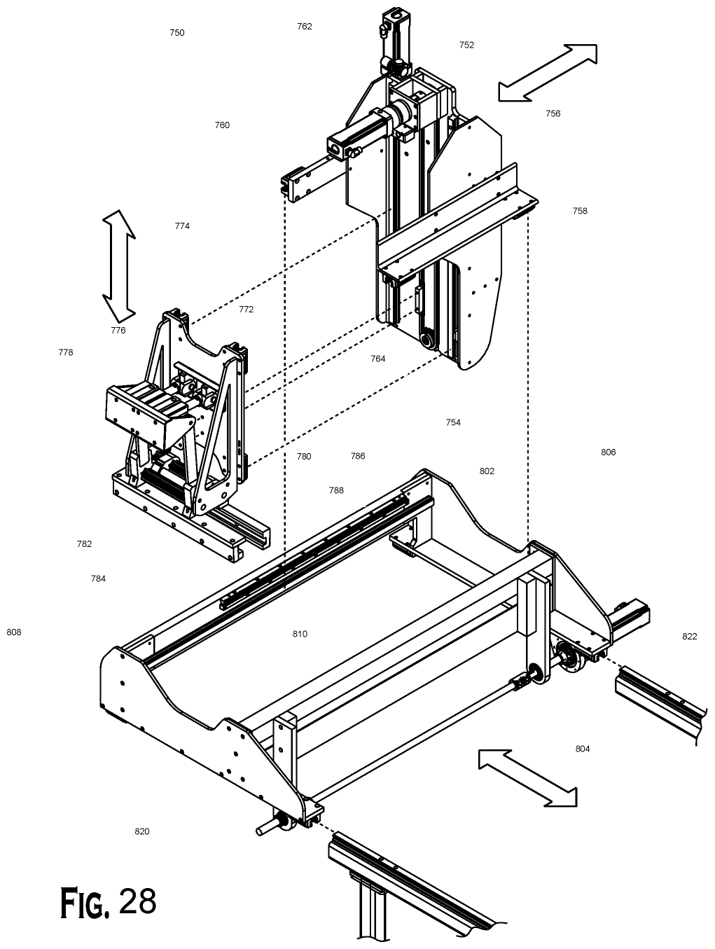

As illustrated in FIG. 27, the arm 732 is an elongated member. The arm 732 further includes a hydraulic piston 734 coupled to the arm 732. One skilled in the art would understand the applicant's design is not the exclusive embodiment. The hydraulic piston 734 couples to a driver 736. The driver 736 is slender blunt member. The hydraulic piston 734 extends and retracts the driver 736 to push the material M down the belt assembly 680.

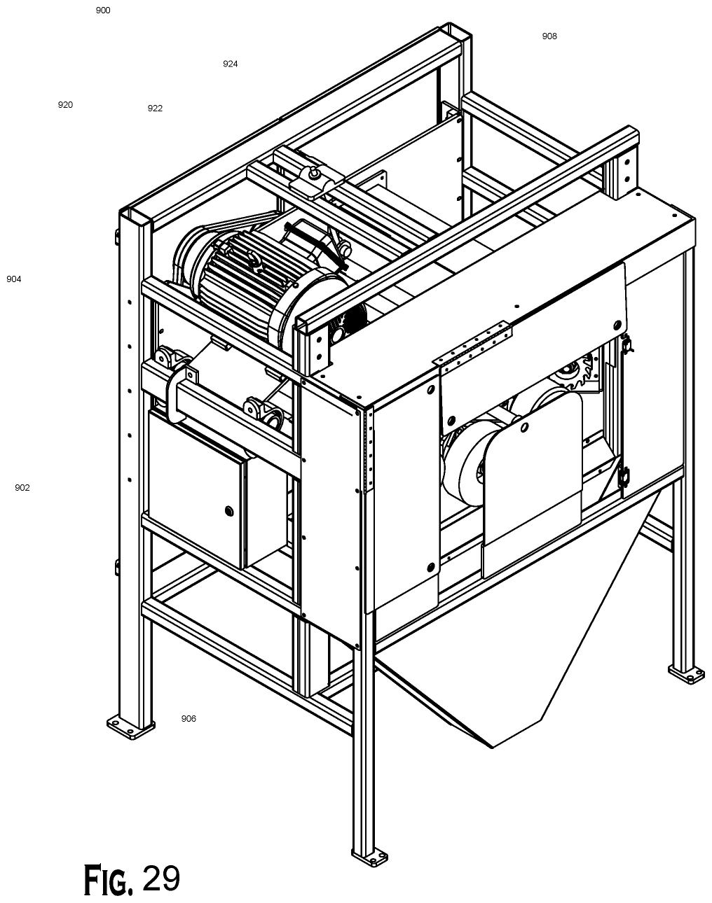

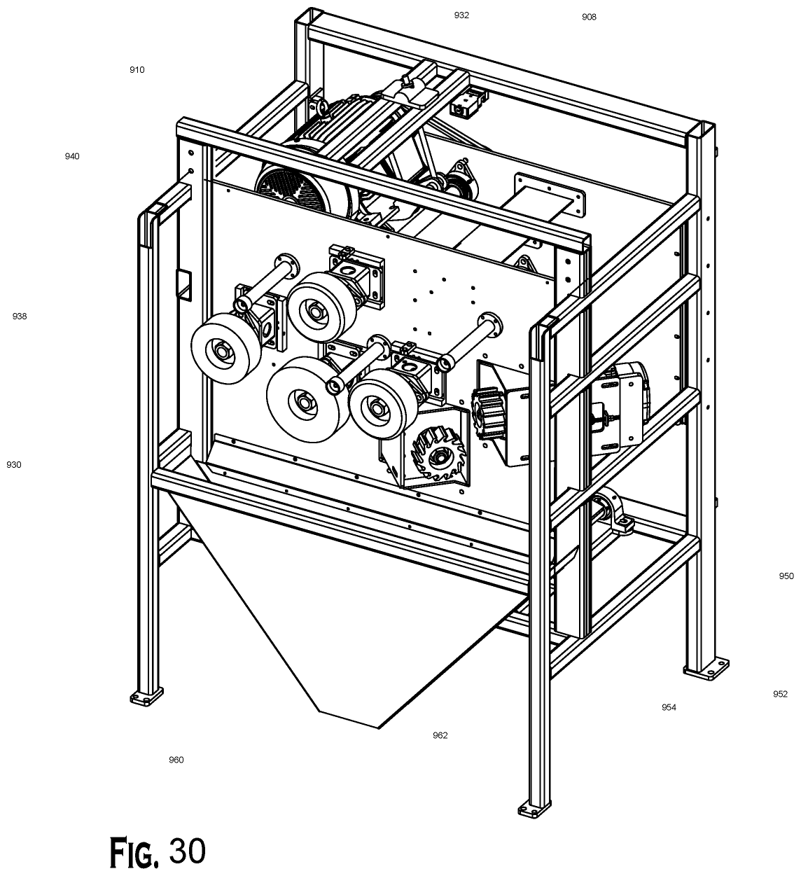

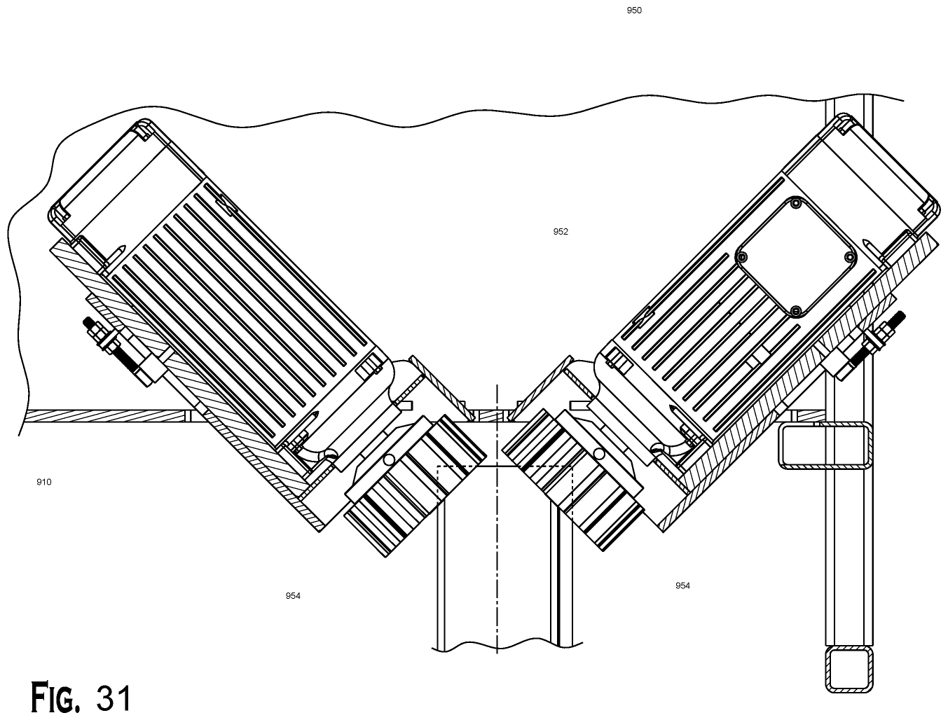

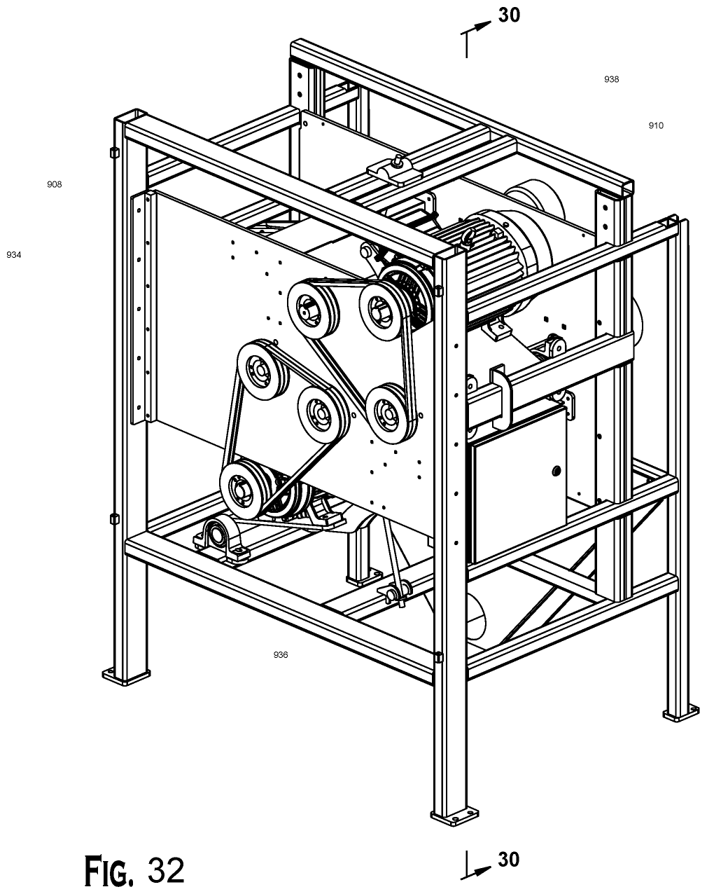

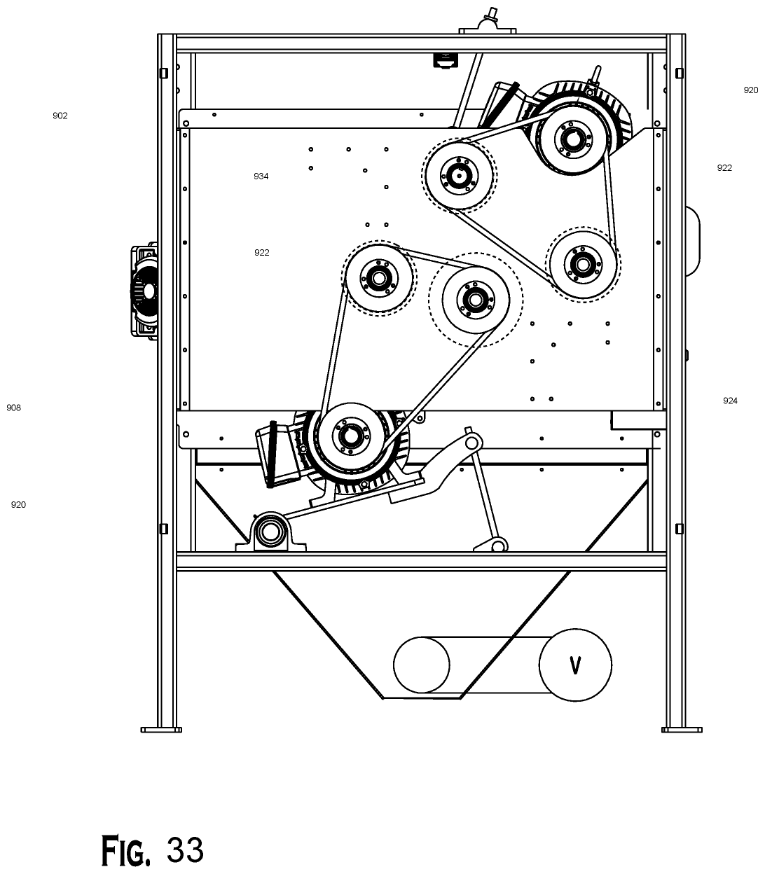

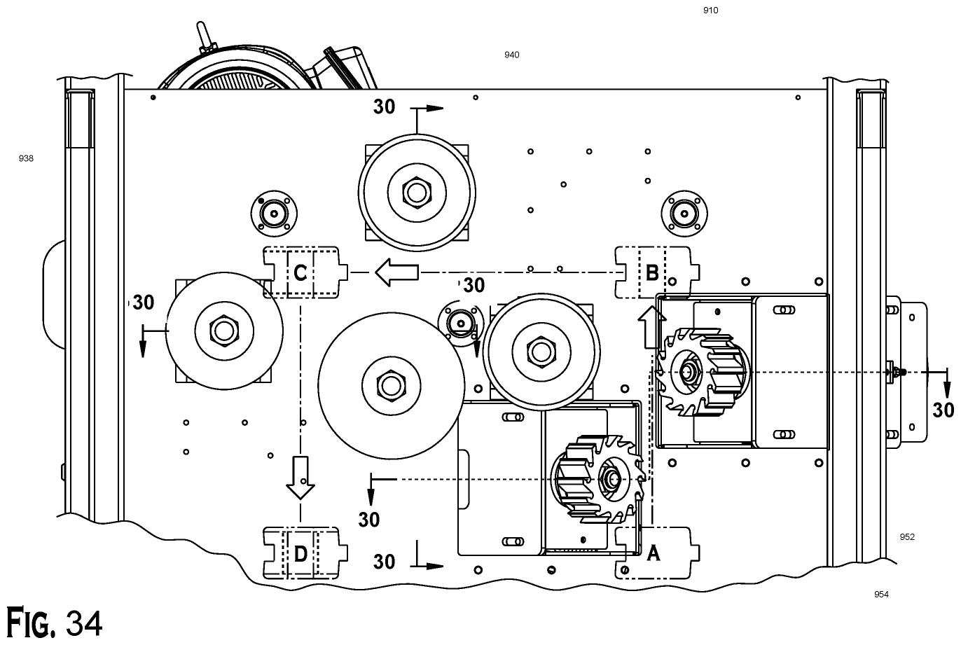

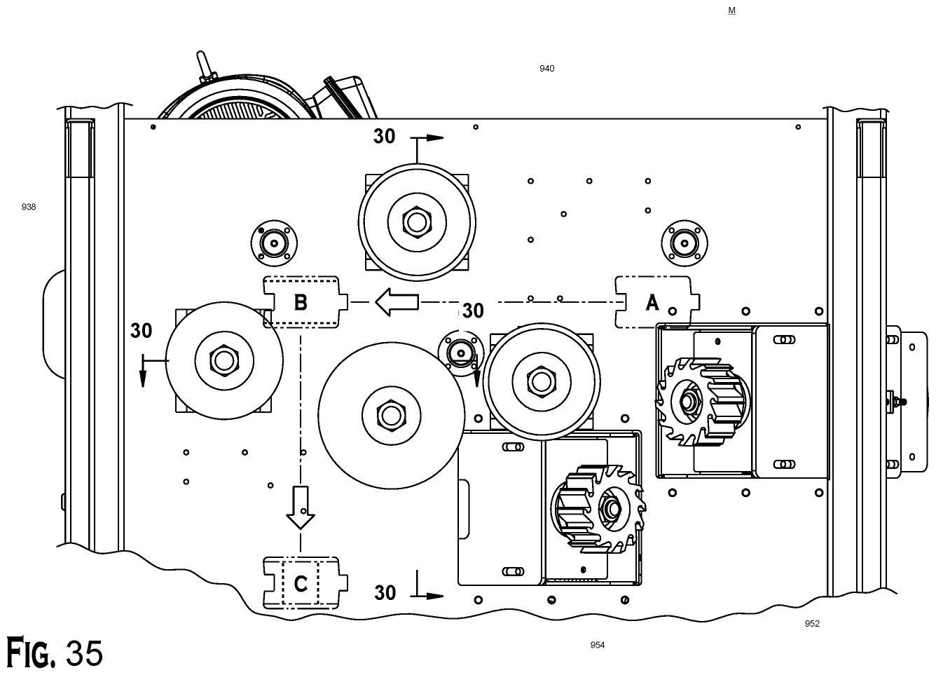

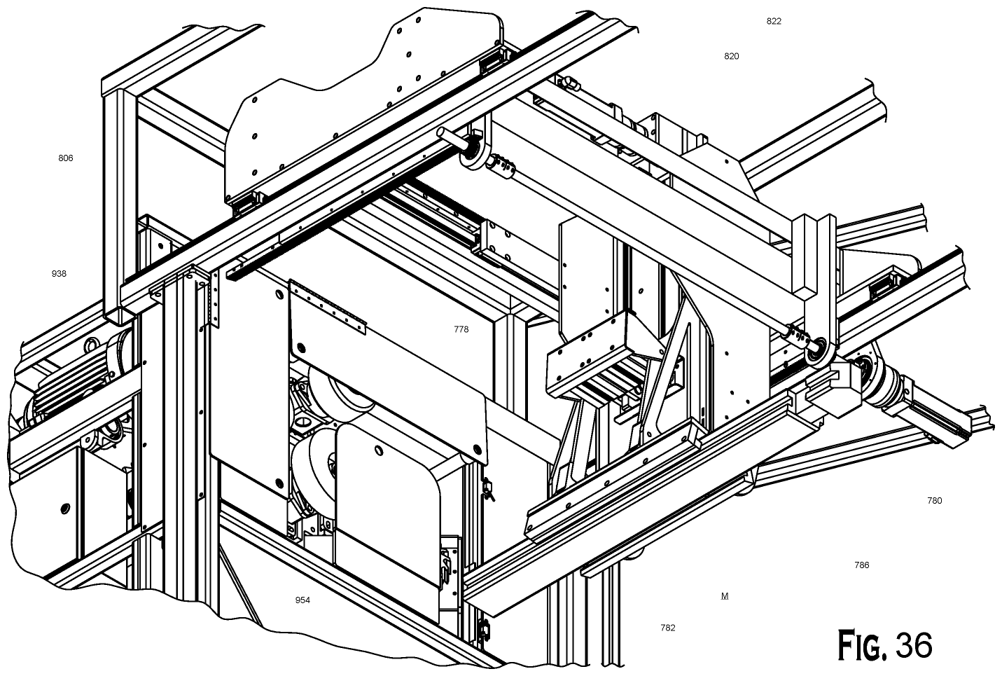

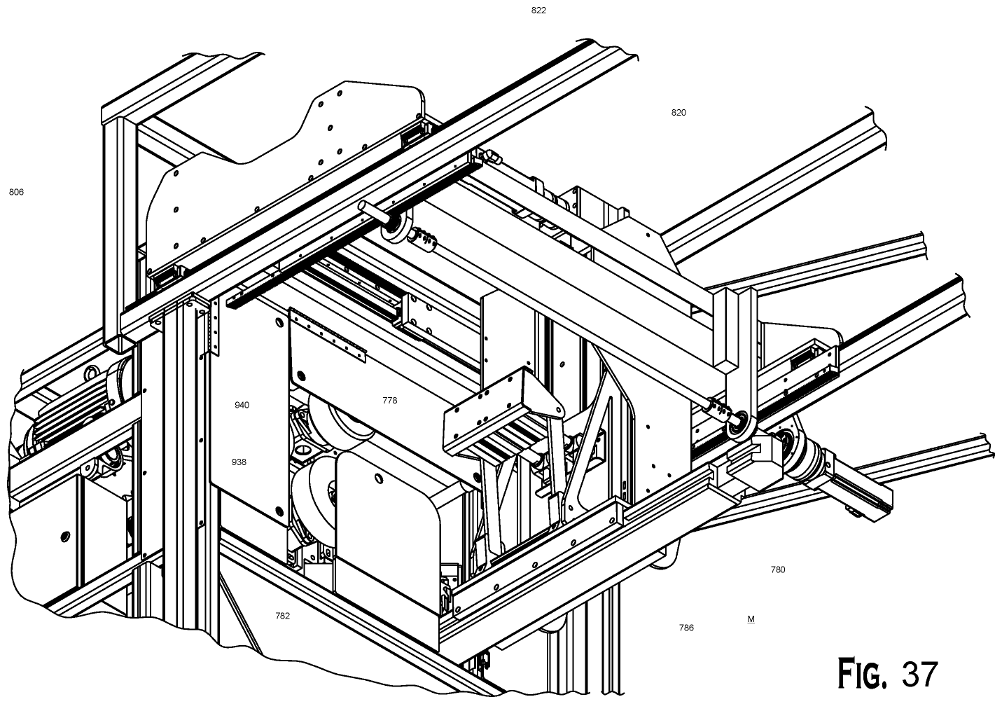

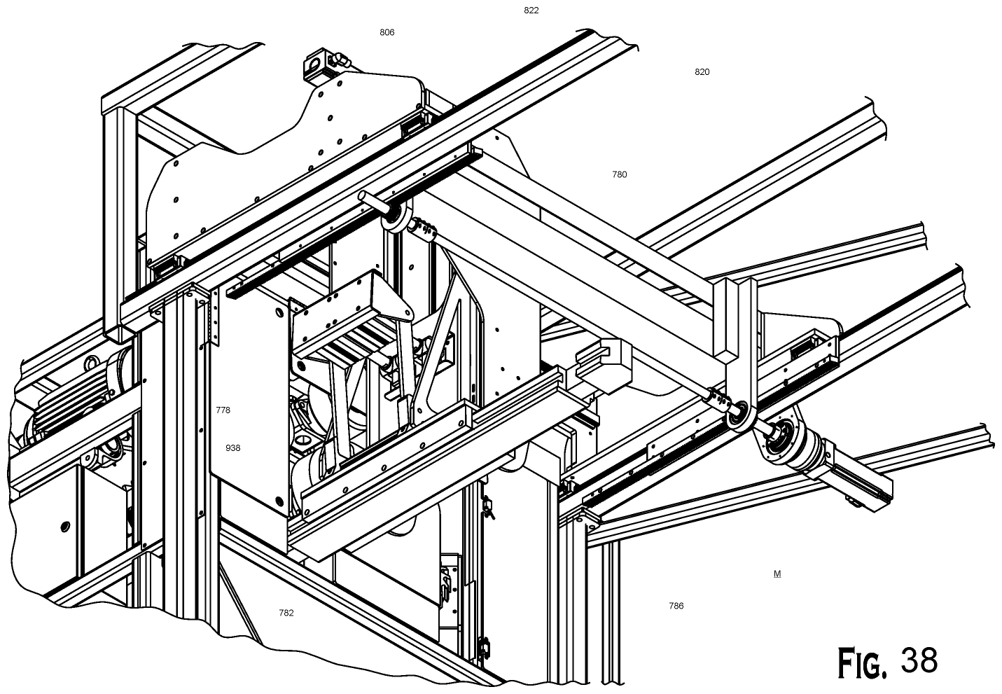

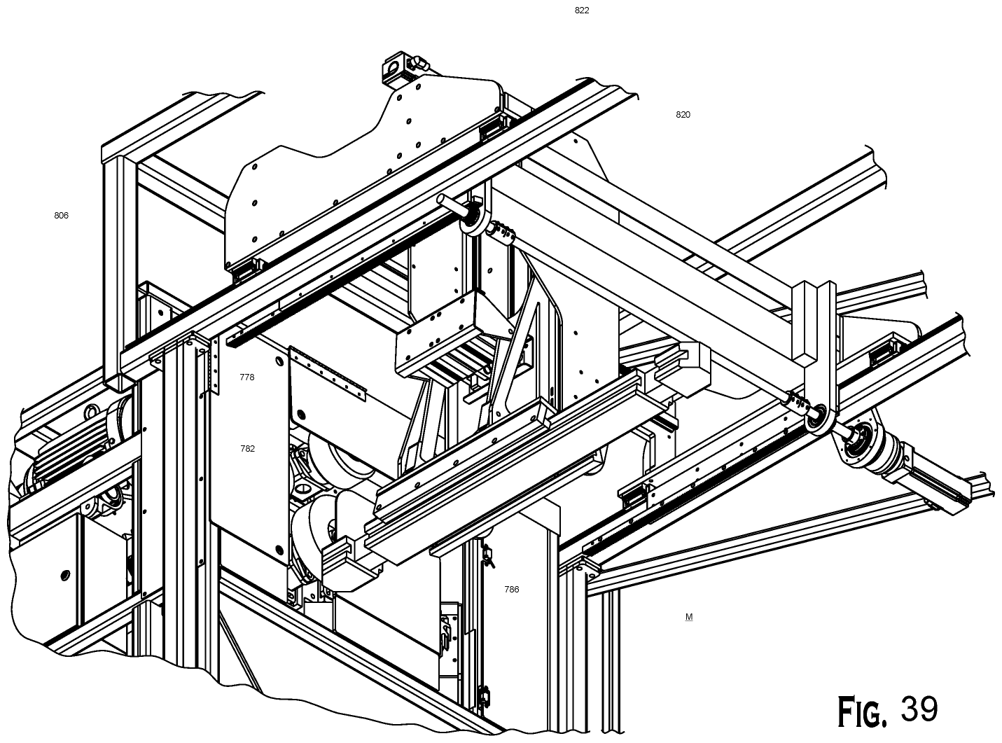

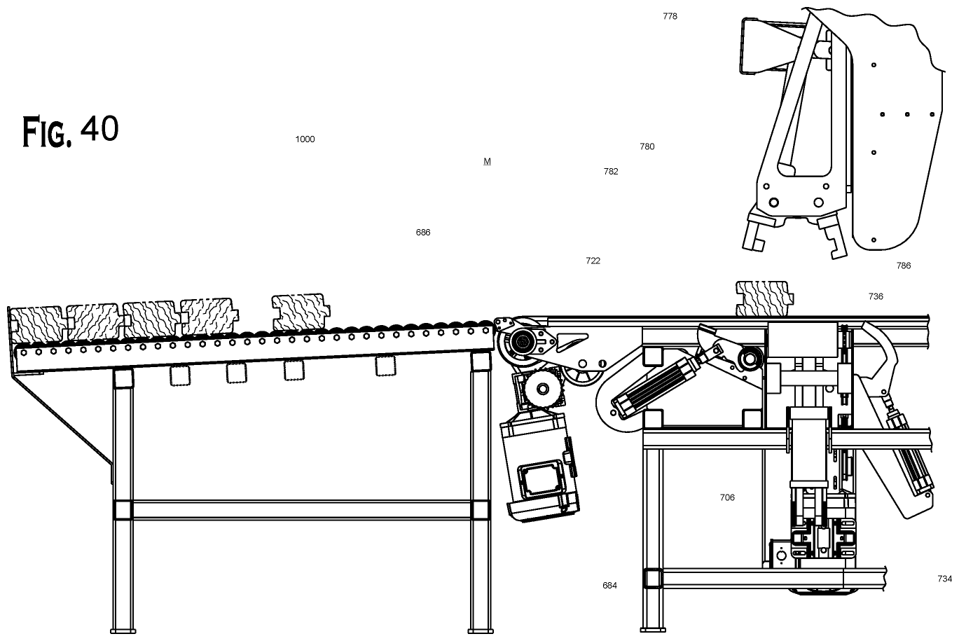

As illustrated in FIG. 28, a crane assembly 740 of the pair of crane assemblies as shown, includes an X movement assembly 750, Y movement assembly 770 and Z movement assembly 800.

The X movement assembly 750 includes a base plate 752. The base plate 752 is an elongated member. The base plate 752 further includes a pair of tracks 754 extending vertically along the base plate 752. The X movement assembly 750 includes a pair of side plates 756. Each side plate 756 is an elongated member extending a length of the base plate 752. The X movement assembly 750 further includes a track receiver 758. The track receiver 758 is positioned horizontally to each side plate 756. The X movement assembly 750 further includes an outward facing track receiver 760. The outward facing track receiver 760 is positioned horizontally to each side plate 756. The X movement assembly 750 further includes a drive motor 762 positioned at an upper portion of the base plate 752. The X movement assembly 750 further includes a glider 764. The glider 764 extends between the pair of tracks 754 and coupled to the drive motor 762.

The Y movement assembly 770 includes a base plate 772. The base plate 772 is an H-shaped member. The base plate 772 further includes a pair of track receivers 774 positioned on an inner portion of the base plate 772. The pair of track receivers 774 align with the pair of tracks 754 of the X movement assembly 750. The base plate 772 further includes a clamp drive motor 776. The clamp drive motor 776 is positioned on an outer portion of the base plate 772. The clamp drive motor 776 further includes a pair of extension members 778 coupled to the clamp drive motor 776. The Y movement assembly 770 further includes a pair of side plates 780. Each side plate 780 is a triangular member positioned against the base plate 772.

The Y movement assembly 770 further includes a first moveable clamp 782. The first moveable clamp 782 is an elongated member. The first moveable clamp 782 further includes a clamp receiver 784. The clamp receiver 784 is formed to receive one side of the material M. The first moveable clamp 782 is coupled to the extension members 778. The Y movement assembly 770 further includes a second moveable clamp 786. The second moveable clamp 786 is an elongated member. The second moveable clamp 786 further includes a clamp receiver 788. The second moveable clamp 788 is formed to receive a second side of the material M. The second moveable clamp 786 is coupled to the extension members 778.

The Z movement assembly 800 includes a base frame 802. The base frame 802 is an H-shaped member. The base frame 802 further includes a pair of rail receivers 804 positioned on a bottom portion of the base frame 802. The Z movement assembly 800 includes a pair of side plates 806. Each side plate 806 is an elongated member positioned vertically against a side of the base frame 802. The Z movement assembly 800 further includes a pair of arch members 808. The pair of arch members 808 extend across the base frame 802. Each arch member 808 includes a track 810.

The crane assembly 740 further includes a plurality of beams 820 extending adjacent each crane assembly 740 of the pair of crane assemblies 740. The plurality of beams further include a track 822 which couples to the pair of rail receivers 804 of the Z movement assembly 800.

A pair of end treatment cabinets 900 are shown. Each end treatment cabinet assembly 900 generally includes a frame 902. The frame 902 generally includes a plurality of vertical beams 904. Each vertical beam 904 is an elongated member. The frame 902 further includes a plurality of horizontal beams 906. Each horizontal beam 906 is an elongated member. The plurality of horizontal beams 906 couple with the plurality of vertical beams 904. Each end treatment cabinet assembly 900 further includes a rear panel 908. Each end treatment cabinet assembly 900 further includes a front panel 910.

The end treatment cabinet assembly 900 further includes a pair of motor mounts 920. Each motor mount 920 further includes an end support 922. Each motor mount further includes a belt 924.

The end treatment cabinet assembly 900 further include a plurality carving assemblies 930.

Each carving assembly 930 generally includes a rotational beam 932. The rotational beam 932 is an elongated cylindrical member. Each carving assembly 930 further includes a rear panel connector 934. The rear panel connector 934 is a circular member. The rear panel connector 934 further includes a belt receiver 936. Each carving assembly 930 further includes a carver head piece 938. The carver head piece 938 is a circular member positioned opposite from the rear panel connector 934.

Each carving assembly 930 further includes a head piece stabilizer 940. The head piece stabilizer 940 abuts between the carver head piece 938 and the front panel 910.

The end treatment cabinet assembly 900 further includes a pair of corner carvers 950. Each of the corner carvers 950 are cylindrical members 952 extending through the front panel 910. Each corner carver 950 further includes carver head piece 954. The carver head piece 954 is keyed as shown.

The end treatment cabinet assembly 900 further includes an end treatment duct 960. The end treatment duct 960 is positioned at the bottom of the frame 902. The end treatment duct 960 is a plurality of tapered walls 962 extending downwards towards an opening. The opening is a passageway to allow debris to pass through.

An operator will place a piece of material on the plurality of rollers 50 of the chop saw table assembly 2. The operator will utilize the control box 72 and enter the appropriate dimensions for the piece of material. The piece of material will be cut and sent along the initial conveyor assembly 180 where the guiding fence 280 of the material guide assembly 220 abuts against the material M.

The operator may choose to transfer the material M along the initial conveyor assembly 180 by the material guide assembly 220 moving along the track 230 of the guiding beams 228. Additionally, the operator can push the material M onto the secondary conveyor assembly 200 by the upper frame supporter 160 extending forward as illustrated in FIG. 14.

The middle frame supporter 130 rotates inwards by the rotational socket 120. Simultaneously, the upper frame supporter 160 extends towards the material M. The material M is then thrusted onto the secondary conveyor assembly 200.

The guiding fence 280 rotates upwards by the pair of rotation beams 260. The material M is then released from the guiding fence 280 of the pair of movers 270.

The material M is transported along the secondary conveyor assembly 200 by the plurality of rollers 208.

In the exemplary embodiment, the material M will continue to the drill unit assembly 400. In another exemplary embodiment, the material M will continue to the initial conveyor carving assembly 600.

The material M is positioned on the plurality of rollers 418. The material is guided through the material receiver 502 by the pair of wheels 494. The material is positioned within the drill unit assembly 400. The plurality of movers 504 stabilize the material within the drill unit assembly 400. The drilling head 560 extends through the material and performs a circular cutout within the material. The plurality of movers 504 then rotate and move the material through the material receiver 502 and onto the plurality of rollers 608 of the initial conveyor carving assembly 600.

The lower arm member 650 of the relocating assembly 630 extends forward while socket 644 rotates. Simultaneously, the upper arm 660 extends forward thrusting the material onto flap 690 where the material M then glides down the belt 686 to the second conveyor carving assembly 700.

The blocker 722 extends upwards and prevents the material from continuing to slide down the belt assembly 680.

The material M is then grasped by the crane assembly 740. Specifically, the first moveable clamp 782 and the second moveable clamp 786 are positioned on an outside of the material. The first moveable clamp 782 and the second moveable clamp 786 proceed to squeeze inwards onto the material by the pair of extension members 778 coupled to the clamp drive motor 776. Thereby, securing the material M.

The crane assembly 740 uses the Z movement assembly 800 to move the material within the end treatment cabinet assembly 900. The crane assembly will then orient the material against the plurality of carvers 930 by the X movement assembly 750 and the Y movement assembly 770. The Z movement assembly 800 will then retract the material from the first end treatment cabinet assembly 900 and begin the same process to a second side of the material in a second end treatment cabinet assembly.

Once both sides of the material are treated, the crane assembly 740 will extend downwards by the Z movement assembly 800. The first moveable clamp 782 and the second moveable clamp 786 which are positioned outside the material will retract.

The blocker 722 will extend downwards. The driver 736 will move the material and allow the material to continue down an exit belt 1000. The operator will then be permitted to grab the material once the material reaches an end of the exit belt 1000.

What is claimed is:

1. A logging machine comprising:
a conveyor assembly having a control box;
an initial conveyor assembly coupled to the conveyor assembly;
a secondary conveyor assembly adjacent the initial conveyor assembly;
an initial conveyor carving assembly coupled to the secondary conveyor assembly;
a secondary conveyor carving assembly coupled to the initial conveyor carving assembly;
a pair of end cabinets positioned on opposing sides of the secondary conveyor carving assembly, a material extended into a first end cabinet and then into a second end cabinet.

2. The logging machine of claim 1, wherein a material guide assembly is positioned adjacent the initial conveyor assembly.

3. The logging machine of claim 2, wherein the material guide assembly further includes a guiding fence positioned above the initial conveyor assembly.

4. The logging machine of claim 3, wherein the material guide assembly extends along the initial conveyor assembly.

5. The logging machine of claim 4, wherein the initial conveyor assembly further includes an upper frame supporter.

6. The logging machine of claim 5, wherein the upper frame supporter extends the material forward onto the secondary conveyor assembly.

7. The logging machine of claim 6, wherein the logging machine further comprises a drill unit assembly.

8. The logging machine of claim 7, wherein the drill unit assembly is coupled between the secondary conveyor assembly and the initial conveyor carving assembly.

9. The logging machine of claim 8, wherein the drill unit assembly includes an arm assembly.

10. The logging machine of claim 9, wherein the arm assembly includes a pair of wheels to push the material into a material receiver of the drill unit assembly.

11. The logging machine of claim 10, wherein the initial conveyor carving assembly further includes a relocating assembly.

12. The logging machine of claim 11, wherein the relocating assembly further includes an upper arm.

13. The logging machine of claim 12, wherein the logging machine further comprises a belt assembly.

14. The logging machine of claim 13, wherein the belt assembly further includes a flap.

15. The logging machine of claim 14, wherein the upper arm extends forward thrusting the material onto the flap.

16. The logging machine of claim 15, wherein the belt assembly further includes a belt coupled between the initial conveyor carving assembly and the secondary conveyor carving assembly.

17. The logging machine of claim 16, wherein the logging machine further comprises a pair of crane assemblies.

18. The logging machine of claim 17, wherein a first crane assembly positions the material within the first end cabinet.
